(19) United States
(12) Patent Application Publication
(10) Pub. No.: US 2013/0234957 A1
(43) Pub. Date: Sep. 12, 2013

(54) INFORMATION PROCESSING APPARATUS AND INFORMATION PROCESSING METHOD

(71) Applicant: SONY CORPORATION, Tokyo (JP)

(72) Inventor: Satoshi Shirato, Nagano (JP)

(73) Assignee: Sony Corporation, Tokyo (JP)

(21) Appl. No.: 13/778,904

(22) Filed: Feb. 27, 2013

(30) Foreign Application Priority Data
Mar. 6, 2012 (JP) 2012-049079

(51) Int. Cl. G06F 3/041

(52) U.S. Cl. CPC G06F 3/0416
USPC 345/173

(57) ABSTRACT

There is provided an information processing apparatus including an extraction section which extracts a first touch region and a second touch region, each satisfying a predetermined region extraction condition, from a plurality of touch positions detected by a touch panel, and a recognition section which recognizes an input event, based on a change in a distance between the first touch region and the second touch region.

### BACKGROUND

The present disclosure relates to an information processing apparatus and an information processing method.

In recent years, touch panels have been used in a large number of devices, such as smart phones, tablet terminals, and game devices. A touch panel achieves the two functions of display and input on one screen.

In order to further simplify operations by such a touch panel, various input events are defined which correspond to a touch or touch gesture on the touch panel. For example, an input event corresponding to a touch, such as the start of the touch, movement of the touch, or end of the touch, and an input event corresponding to a touch gesture, such as drag, tap, pinch in or pinch out, are defined. Further, not being limited to these typical input events, input events for further simplifying operations have been proposed.

For example, technology is disclosed in JP 2011-238125A which recognizes an input event corresponding to a touch gesture, in which the side surface of a hand moves while touching the touch panel, and selects and moves an object according to this input event.

### SUMMARY

However, when an input event is applied to the operations of a large-sized touch panel in the related art, a large burden may occur for a user. For example, large movements of the user's body may be necessary in order to operate an object over a wide range.

Accordingly, it is desired to enable a user to perform operations for a large-sized touch panel with less of a burden.

According to an embodiment of the present disclosure, there is provided an information processing apparatus including an extraction section which extracts a first touch region and a second touch region, each satisfying a predetermined region extraction condition, from a plurality of touch positions detected by a touch panel, and a recognition section which recognizes an input event, based on a change in a distance between the first touch region and the second touch region.

Further, according to an embodiment of the present disclosure, there is provided an information processing method including extracting a first touch region and a second touch region, each satisfying a predetermined region extraction condition, from a plurality of touch positions detected by a touch panel, and recognizing an input event, based on a change in a distance between the first touch region and the second touch region.

According to the above described information processing apparatus and information processing method according to an embodiment of the present disclosure, it is possible for a user to perform operations for a large-sized touch panel with less of a burden.

### BRIEF DESCRIPTION OF THE DRAWINGS

FIG. 1 is an outline view which shows an example of the appearance of an information processing apparatus according to an embodiment of the present disclosure;

FIG. 2 is a block diagram which shows an example of a hardware configuration of the information processing apparatus according to an embodiment of the present disclosure;

FIG. 3 is a block diagram which shows an example of a functional configuration of the information processing apparatus according to an embodiment of the present disclosure;

FIG. 4A is an explanatory diagram for describing a first example of the detection of a touch position;

FIG. 4B is an explanatory diagram for describing a second example of the detection of a touch position;

FIG. 5 is an explanatory diagram for describing an example of the extraction of a touch region;

FIG. 6 is an explanatory diagram for describing an example of the density of a touch position included in a touch region;

FIG. 7A is an explanatory diagram for describing an example of the recognition of a GATHER event;

FIG. 7B is an explanatory diagram for describing an example of the recognition of a SPLIT event;

FIG. 8 is an explanatory diagram for describing an example of the recognition of an input event, based on an amount of change in the distance between touch regions;

FIG. 9A is an explanatory diagram for describing an example of the recognition of an input event, based on a relative moving direction between two touch regions;

FIG. 9B is an explanatory diagram for describing an example of the recognition of an input event, based on a moving direction of two touch regions;

FIG. 10 is an explanatory diagram for describing examples of the recognition of other input events;

FIG. 11A is an explanatory diagram for describing an example of the change of display for objects to be operated by a GATHER event;

FIG. 11B is an explanatory diagram for describing another example of the change of display for objects to be operated by a GATHER event;

FIG. 12A is an explanatory diagram for describing a first example of the change of display for objects to be operated by a SPLIT event;

FIG. 12B is an explanatory diagram for describing a second example of the change of display for objects to be operated by a SPLIT event;

FIG. 12C is an explanatory diagram for describing a third example of the change of display for objects to be operated by a SPLIT event;

FIG. 13A is an explanatory diagram for describing an example of the change of display for an object to be operated by a GRAB event;

FIG. 13B is an explanatory diagram for describing an example of the change of display for an object to be operated by a SHAKE event;

FIG. 13C is an explanatory diagram for describing an example of the change of display for an object to be operated by a CUT event;

FIG. 13D is an explanatory diagram for describing an example of the change of display for an object to be operated by a CIRCLE event;

FIG. 13E is an explanatory diagram for describing an example of an operation for objects to be operated by a WIPE event;

FIG. 13F is an explanatory diagram for describing an example of an operation for objects to be operated by a FADE event;

FIG. 14A is a first explanatory diagram for describing an operation example in the information processing apparatus;

FIG. 14B is a second explanatory diagram for describing an operation example in the information processing apparatus;

FIG. 14C is a third explanatory diagram for describing an operation example in the information processing apparatus;

FIG. 14D is a fourth explanatory diagram for describing an operation example in the information processing apparatus;

FIG. 14E is a fifth explanatory diagram for describing an operation example in the information processing apparatus;

FIG. 14F is a sixth explanatory diagram for describing an operation example in the information processing apparatus;

FIG. 15 is a flow chart which shows an example of a schematic flow of an information process according to an embodiment of the present disclosure;

FIG. 16 is a flow chart which shows an example of a touch region extraction process;

FIG. 17 is a flow chart which shows an example of a GATHER/SPLIT recognition process; and

FIG. 18 is a flow chart which shows an example of a GATHER/SPLIT control process.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Appearance of the information processing apparatus

2. Configuration of the information processing apparatus
2.1. Hardware configuration
2.2. Functional configuration

3. Operation examples

4. Process flow

5. Conclusion

### 1. APPEARANCE OF THE INFORMATION PROCESSING APPARATUS

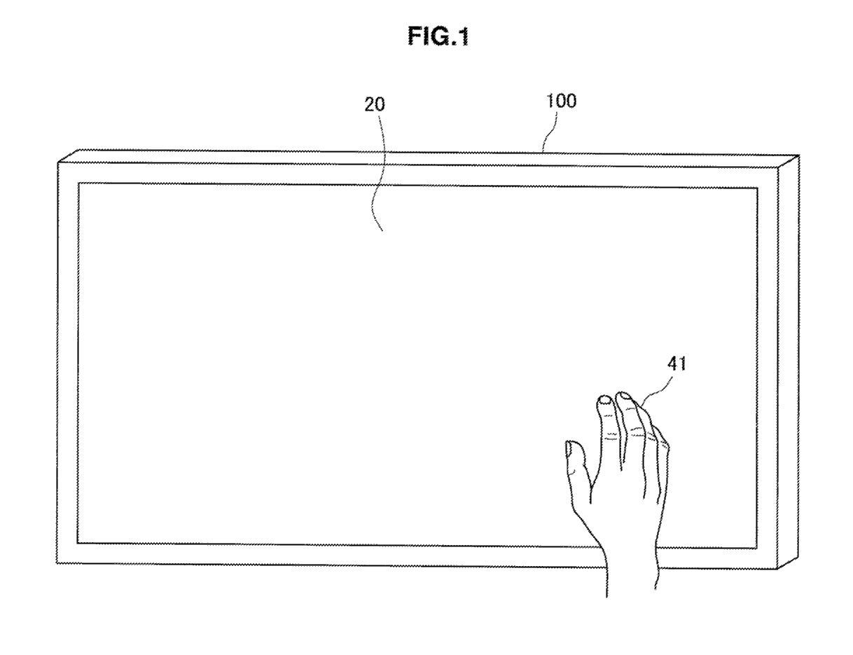

First, the appearance of an information processing apparatus 100 according to one embodiment of the present disclosure will be described with reference to FIG. 1. FIG. 1 is an outline view which shows an example of the appearance of the information processing apparatus 100 according to the present embodiment. Referring to FIG. 1, the information processing apparatus 100 is shown. The information processing apparatus 100 includes a touch panel 20. Further, the information processing apparatus 100, for example, is a large-sized touch panel. That is, the touch panel 20 is a large-sized touch panel which is considerably larger compared with a user's hand 41.

The user can operate an object displayed on the touch panel 20, by touching the touch panel 20 with their hand 41. However, in the case where objects are scattered in a wide range of the large-sized touch panel 20, large movements of the user's body may be necessary when the user tries to operate these objects with only one hand. As a result, a large burden may occur for the user.

According to the information processing apparatus 100 of the present embodiment, it is possible for a user to perform operations for the large-sized touch panel 20 with less of a burden. Hereinafter, these specific contents will be described in: <2. Configuration of the information processing apparatus>, <3. Operation examples> and <4. Process flow>.

### 2. CONFIGURATION OF THE INFORMATION PROCESSING APPARATUS

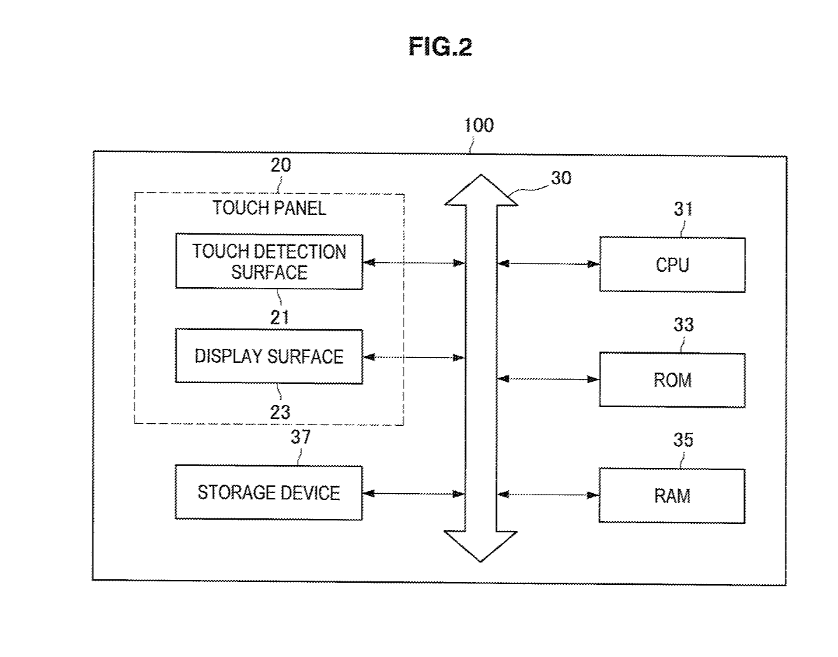

Next, a configuration of the information processing apparatus 100 according to one embodiment of the present disclosure will be described with reference to FIGS. 2 to 13F.

### <2.1. Hardware Configuration>

First, an example of a hardware configuration of the information processing apparatus 100 according to the present embodiment will be described with reference to FIG. 2. FIG. 2 is a block diagram which shows an example of a hardware configuration of the information processing apparatus 100 according to the present embodiment. Referring to FIG. 2, the information processing apparatus 100 includes a touch panel 20, a bus 30, a CPU (Central Processing Unit) 31, a ROM (Read Only Memory) 33, a RAM (Random Access Memory) 35, and a storage device 37.

The touch panel 20 includes a touch detection surface 21 and a display surface 23. The touch detection surface 21 detects a touch position on the touch panel 20. More specifically, for example, when a user touches the touch panel 20, the touch detection surface 21 perceives this touch, generates an electric signal according to the position of this touch, and then converts this electric signal to information of the touch position. The touch detection surface 21 is a multi-touch compatible touch detection surface capable of detecting a plurality of touch positions. Further, the touch detection surface 21, for example, can be formed in accordance with an arbitrary touch detection system, such as an electrostatic capacity system, a resistive membrane system, or an optical system.

The display surface 23 displays an output image from the information processing apparatus 100. The display surface 23, for example, can be realized by using liquid crystals, organic ELs (Organic Light-Emitting Diodes: OLEDs), a CRT (Cathode Ray Tube), or the like.

The bus 30 mutually connects the touch detection surface 21, the display surface 23, the CPU 31, the ROM 33, the RAM 35 and the storage device 37.

The CPU 31 controls the overall operations of the information processing apparatus 100. The ROM 33 stores programs and data which configure software executed by the CPU 31. The RAM 35 temporarily stores the programs and data when executing the processes of the CPU 31.

The storage device 37 stores the programs and data which configure the software executed by the CPU 31, as well as other data which is to be temporarily or permanently stored. The storage device 37, for example, may be a magnetic recording medium such as a hard disk, or it may be a non-volatile memory, such as an EEPROM (Electrically Erasable and Programmable Read Only Memory), a flash memory, an MRAM (Magnetoresistive Random Access Memory), a FeRAM (Ferroelectric Random Access Memory), or a PRAM (Phase change Random Access Memory).

### <2.2 Functional Configuration>

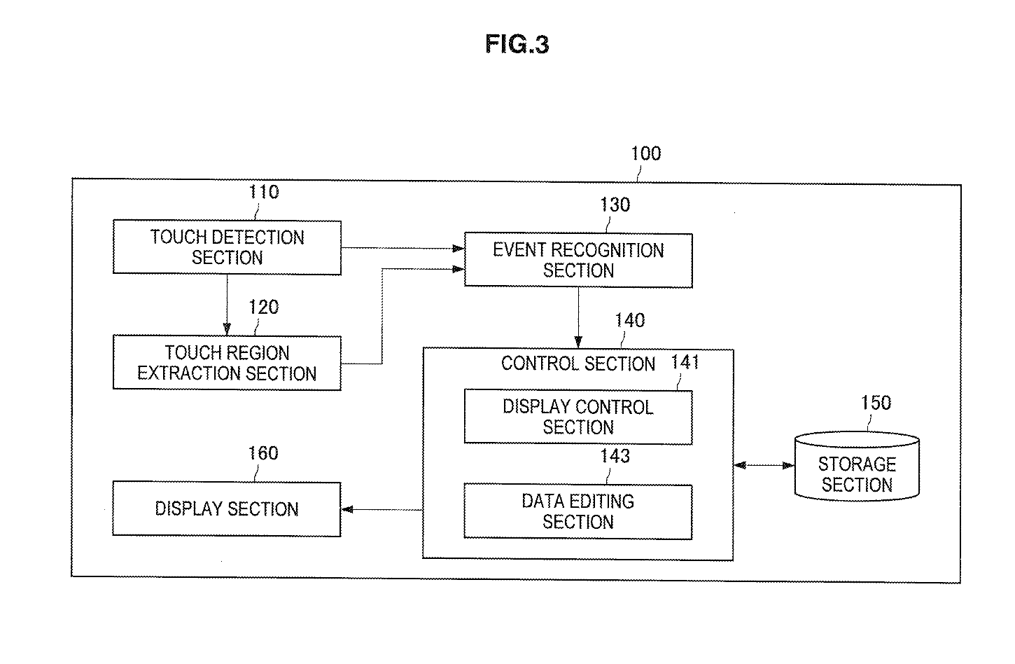

Next, an example of a functional configuration of the information processing apparatus 100 according to the present embodiment will be described with reference to FIGS. 3 to 13F. FIG. 3 is a block diagram which shows an example of a functional configuration of the information processing apparatus 100 according to the present embodiment. Referring to FIG. 3, the information processing apparatus 100 includes a touch detection section 110, a touch region extraction section 120, an event recognition section 130, a control section 140, a storage section 150, and a display section 160.

### (Touch Detection Section 110)

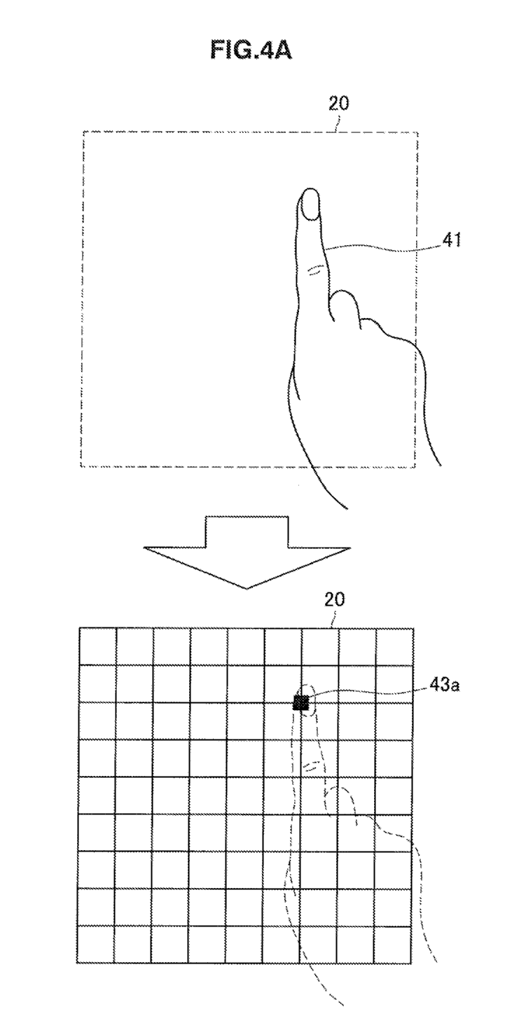

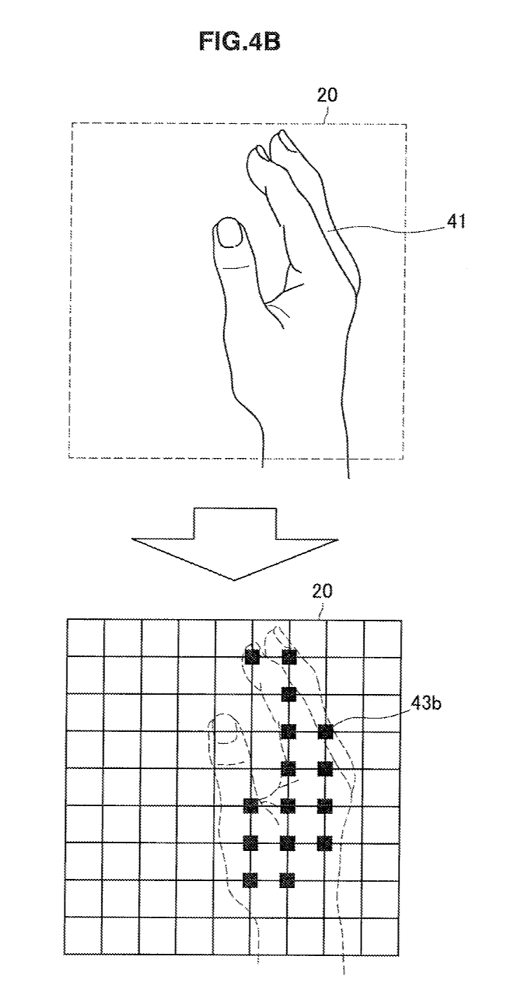

The touch detection section 110 detects a touch position on the touch panel 20. That is, the touch detection section 110 has a function corresponding to the touch detection surface 21. This touch position, for example, is a set of coordinates in the touch panel 20. In the case where a user performs a touch in a plurality of positions, the touch detection section 110 detects a plurality of touch positions. Hereinafter, the detection of touch positions will be described more specifically with reference to FIGS. 4A and 4B.

First, FIG. 4A is an explanatory diagram for describing a first example of the detection of a touch position. Referring to FIG. 4A, in the upper section, part of the touch panel 20 and a user's hand 41 are shown. Here, the user is touching the touch panel 20 with one finger of their hand 41. On the other hand, in the lower section, part of the touch panel 20 is shown with coordinates, and a touch position 43a is shown which is detected according to a touch with one finger of the user's hand 41. In this way, the touch detection section 110, for example, detects one touch position 43a according to a touch with one finger of the user's hand 41.

Further, FIG. 4B is an explanatory diagram for describing a second example of the detection of a touch position. Referring to FIG. 4B, in the upper section, part of the touch panel 20 and a user's hand 41 are shown. Here, the user is touching the touch panel 20 with a side surface of their hand 41. On the other hand, in the lower section, part of the touch panel 20 is shown with coordinates, and touch positions 43b are shown which are detected according to a touch with the side surface of the user's hand 41. In this way, the touch detection section 110, for example, detects a number of clustered touch positions 43b according to a touch with the side surface of the user's hand 41.

The touch detection section 110 outputs the detected touch positions 43 to the touch region extraction section 120 and the event recognition section 130 in a time series.

### (Touch Region Extraction Section 120)

The touch region extraction section 120 extracts a touch region satisfying a predetermined region extraction condition from a plurality of touch positions detected by the touch panel 20. More specifically, for example, in the case where the touch detection section 110 has detected a plurality of touch positions, the touch region extraction section 120 groups the detected plurality of touch positions into one or more touch position sets, in accordance with a predetermined grouping condition. Here, the grouping condition, for example, may be a condition where the distance between arbitrary pairs of touch positions belonging to each group does not exceed a predetermined condition. Also, the touch region extraction section 120 judges whether or not a region including this touch position set satisfies the region extraction condition, for each touch position set, and the regions which satisfy the region extraction condition are extracted as touch regions. Hereinafter, the region extraction condition will be described more specifically.

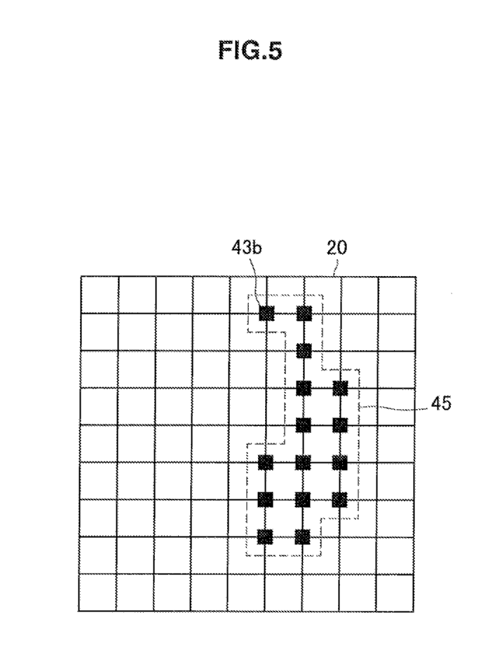

The above described region extraction condition, for example, includes a condition for the size of the touch region to be extracted (hereinafter, called a “size condition”). More specifically, for example, this size condition is a condition for an area of the touch region to be extracted. As an example, this size condition is an area of the touch region which is equal to or more than a first size threshold, and is less than a second size threshold. Here, the area of the touch region, for example, is a pixel number included in the touch region. The first and second size thresholds, which are compared with the area of the touch region, for example, may be predetermined based on a standard size of a user's hand. Hereinafter, the extraction of a touch region, in the case where the region extraction condition is a size condition, will be described more specifically with reference to FIG. 5.

FIG. 5 is an explanatory diagram for describing an example of the extraction of the touch region. Referring to FIG. 5, similar to that of FIG. 4B, part of the touch panel 20 is shown with coordinates. Further, similar to that of FIG. 4B, touch positions 43b are shown which have been detected in the case where a user has touched the touch panel 20 with the side surface of their hand 41. In this case, the touch region extraction section 120 first specifies a plurality of touch positions 43, that is, a touch position set, which satisfies the above described grouping condition, and further specifies a region 45 including this touch position set. Here, the size condition is an area of the touch region which has a pixel number equal to or more than a first size threshold and less than a second size threshold. In this case, the region 45 including the touch position set includes pixels equal to or more than a first size threshold and less than a second size threshold, and the touch region extraction section 120 judges whether or not the region 45 satisfies the size condition. As a result, the touch region extraction section 120 extracts the region 45 satisfying the size condition as a touch region.

From such a size condition, it becomes possible to distinguish a touch with a specific part of the user's hand 41 from a touch with another part of the user's hand 41, by a simple operation. For example, it becomes possible to distinguish a touch with the side surface of the user's hand 41 from a touch with a part other than the side surface (for example, a finger or the palm) of the user's hand 41.

Note that the size condition may be simply an area of the touch region which is equal to or more than a first size threshold. Further, the size condition may be a condition for a length of the touch region instead of a condition for the area of the touch region. As an example, the size condition may be a distance between the two furthest coordinates from among the coordinates in the touch region which are equal to or more than a predetermined threshold. Further, the size condition may be a combination between a condition for an area of the touch region and a condition for a length of the touch region.

Further, the above described region extraction condition may include a condition for a shape of the touch region to be extracted (hereinafter, called a “shape condition”). More specifically, for example, this shape condition is a pre-prepared region pattern which is similar to the touch region. As an example, this region pattern is a region acquired as a sample from a touch with a specific part (for example, the side surface) of the user's hand 41. This region pattern is acquired for many users' hands 41. The touch region extraction section 120 compares the region 45 including the touch position set with each region pattern. Then, in the case where the area 45 including the touch position set is similar to one of the region patterns, the touch region extraction section 120 judges whether or not the region 45 including the touch position set satisfies a shape condition. In the case where the region extraction condition is a shape condition, such as in this case, the touch region extraction section 120 extracts the region 45 satisfying the shape condition as a touch region.

For such a shape condition, it becomes possible to finely distinguish a touch with a specific part of the user's hand 41 from a touch with another part of the user's hand 41. For example, not only does it become possible to distinguish a touch with the side surface of the user's hand 41 from a touch with a part other than the side surface (for example, a finger or the palm) of the user's hand 41, but it also becomes possible to distinguish a touch with the side surface of the right hand from a touch with the side surface of the left hand. As a result, it becomes possible to comprehend which of the user's hands it is facing.

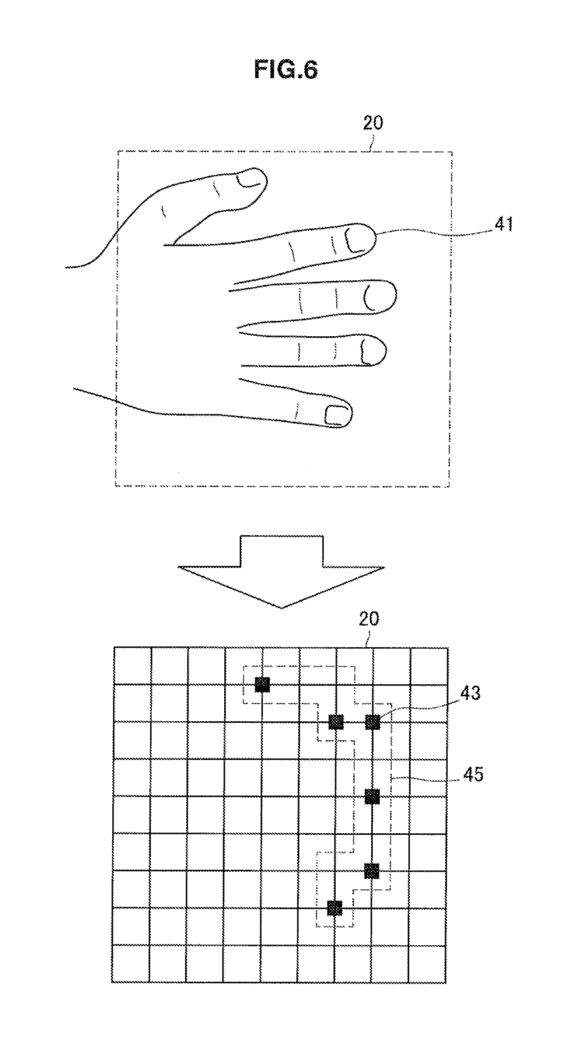

Further, the above described region extraction condition may include a condition for a density of the touch position included in the touch region to be extracted (hereinafter, called a “density condition”). More specifically, for example, this density condition is a ratio of the number of touch positions to the area of the touch region which is equal to or more than a density threshold. This density condition, for example, is used in combination with the size condition or the shape condition. That is, this density condition is included in the size condition or shape condition along with the region extraction condition. The extraction of touch regions by the size condition and the density condition will be described more specifically with reference to FIG. 6.

FIG. 6 is an explanatory diagram for describing an example of the density of a touch position included in a touch region. Referring to FIG. 6, in the upper section, part of the touch panel 20 and a user's hand 41 are shown. Here, the user is touching the touch panel 20 with five fingers of their hand 41. On the other hand, in the lower section, part of the touch panel 20 is shown with coordinates, and touch positions 43 are shown, which have been detected according to a touch with five fingers of the user's hand 41. In this way, the touch detection section 110, for example, detects six touch positions 43 according to a touch with five fingers of the user's hand 41. Here, in the case where the six touch positions 43 satisfy the above described grouping condition, the touch region extraction section 120 groups the six touch positions 43 as a touch position set. Then, the touch region extraction section 120 judges whether or not the region 45 including this touch position set satisfies a size condition and a density condition. Here, for example, the region 45 includes pixels equal to or more than a first size threshold and less than a second size threshold, and the touch region extraction section 120 judges whether or not the region 45 satisfies the size condition. On the other hand, the region 45 has a low ratio of the number of touch positions (6) to the area, for example, and this ratio is less than the above described density threshold. Therefore, the touch region extraction section 120 judges that the region 45 does not satisfy the density condition, and does not extract the region 45 as a touch region.

On the other hand, referring again to FIG. 5, the region 45 has a high ratio of the number of touch positions (15) to the area, for example, and this ratio is equal to or more than the above described density threshold. Therefore, the touch region extraction section 120 judges that the region 45 satisfies the density condition, and extracts the region 45 as a touch region.

From such a density condition, it becomes possible to finely distinguish a touch with a specific part of the user's hand 41 from a touch with another part of the user's hand 41. For example, as described above, it becomes possible to distinguish a touch with the side surface of the user's hand 41 from a touch with a plurality of fingers of the user's hand 41.

Heretofore, the extraction of a touch region by a region extraction condition has been described. According to such an extraction, when there has been a touch with a specific part (for example, the side surface) of the user's hand 41, it becomes possible to comprehend the region which has been touched with this specific part. That is, as described above, it becomes possible to define an input event by a touch with a specific part (for example, the side surface) of the user's hand 41. As an example, since the side surfaces of a user's hands 41 are used in the case where objects placed on a desk are gathered up, for example, if the side surfaces of the user's hands 41 are able to be used for operations with the touch panel 20, it becomes possible to more intuitively perform the operations. Further, since there is a direction, such as to the palm or to the back of the hand, for the side surface of the user's hand 41, if input events based on these directions are defined, operations which consider the direction of the side surface of the user's hand, and operations in which it may be necessary to distinguish the right hand from the left hand, can be realized.

### (Event Recognition Section 130)

The event recognition section 130 recognizes an input event corresponding to the touch positions detected by the touch panel 20. In particular, in the case where a first touch region and a second touch region, each satisfying the region extraction condition, are extracted, the event recognition section 130 recognizes an input event, based on a change in distance between this first touch region and this second touch region. Hereinafter, this point will be described in more detail.

### —GATHER Event/SPLIT Event

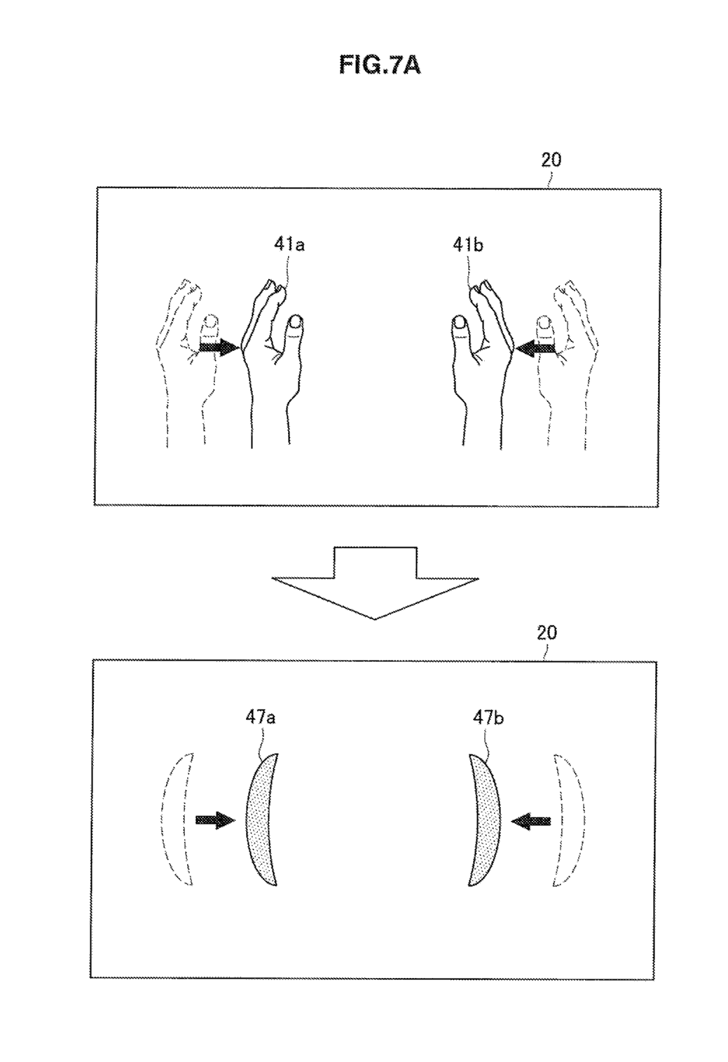

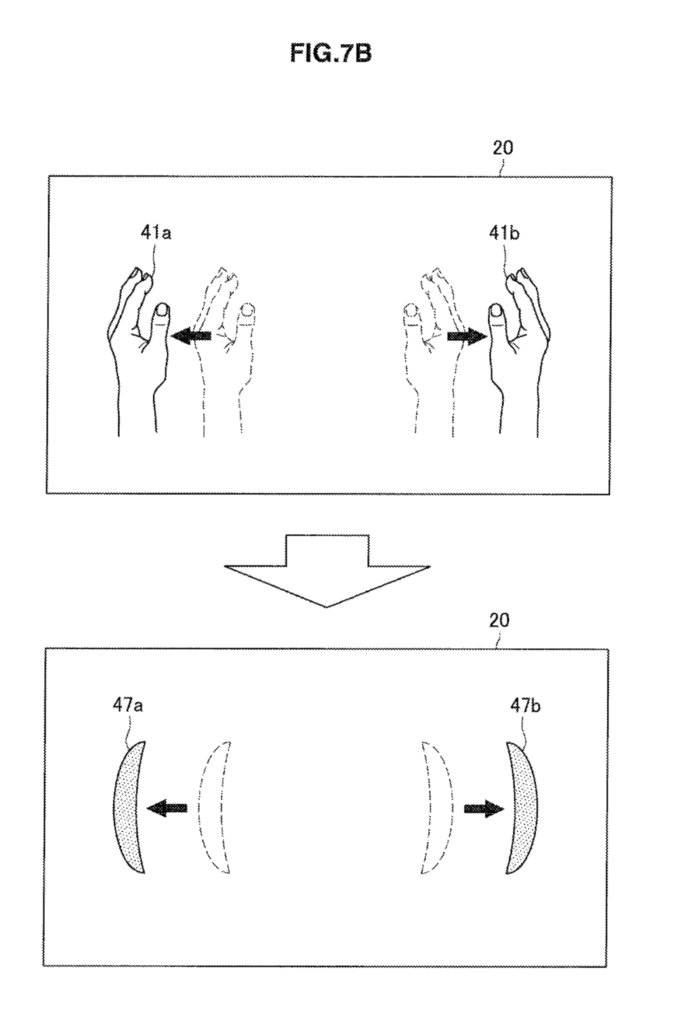

First, for example, in the case where the distance between the first touch region and the second touch region becomes smaller, the event recognition section 130 recognizes a first input event (hereinafter, called a “GATHER event”). Further, for example, in the case where the distance between the first touch region and the second touch region becomes larger, the event recognition section 130 recognizes a second input event (hereinafter, called a “SPLIT event”). These input events will be described more specifically with reference to FIGS. 7A and 7B.

First, FIG. 7A is an explanatory diagram for describing an example of the recognition of a GATHER event. Referring to FIG. 7A, in the upper section, part of the touch panel 20 along with the user's left hand 41a and right hand 41b are shown. The user moves the specific parts (that is, the side surfaces) of their left hand 41a and right hand 41b in directions mutually approaching one another while touching the touch panel 20. In this case, since the extracted first touch region 47a and second touch region 47b move in directions mutually approaching one another in a similar way to that of the user's left hand 41a and right hand 41b, the distance between the first touch region 47a and the second touch region 47b becomes smaller. Therefore, the event recognition section 130 recognizes a GATHER event corresponding to such a touch gesture of the user's left hand user 41a and right hand 41b.

Further, FIG. 7B is an explanatory diagram for describing an example of the recognition of a SPLIT event. Referring to FIG. 7B, in the upper section, part of the touch panel 20 along with the user's left hand 41a and right hand 41b are shown. The user moves the specific parts (that is, the side surfaces) of their left hand 41a and right hand 41b in directions mutually separating from one another while touching the touch panel 20. In this case, since the extracted first touch region 47a and second touch region 47b move in directions mutually separating from one another in a similar way to that of the user's left hand 41a and right hand 41b, the distance between the first touch region 47a and the second touch region 47b becomes larger. Therefore, the event recognition section 130 recognizes a SPLIT event, corresponding to such a touch gesture of the user's left hand 41a and right hand 41b.

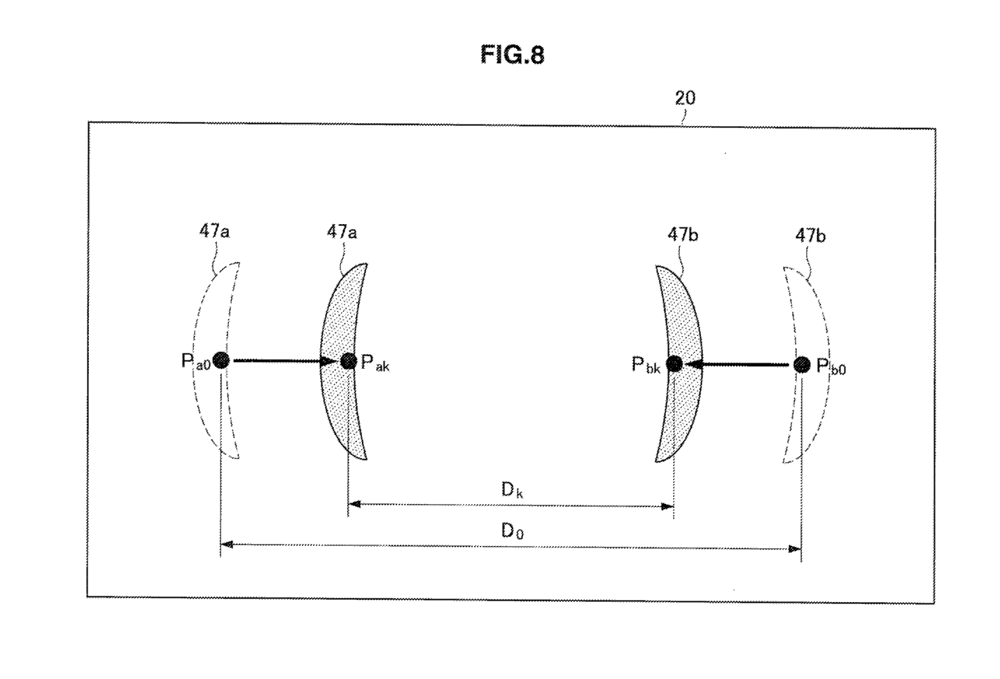

A GATHER event and a SPLIT event such as described above are recognized. Describing the process more specifically, for example, the event recognition section 130 recognizes an input event (that is, a GATHER event or a SPLIT event), based on an amount of change in the distance between the first touch region and the second touch region. Hereinafter, this point will be described more specifically with reference to FIG. 8.

FIG. 8 is an explanatory diagram for describing an example of the recognition of an input event, based on an amount of change in the distance between touch regions. Referring to FIG. 8, the touch panel 20 is shown. For example, when the first touch region 47a and second touch region 47b are extracted, the event recognition section 130 determines a representative point Pa0 for this first touch region 47a and a representative point Pb0 for this second touch region 47b. As an example, the event recognition section 130 determines the center of gravity of the touch regions 47 as the representative points of these touch regions 47. Next, the event recognition section 130 calculates an initial distance D0 between the representative point Pa0 of the first touch region 47a and the representative point Pb0 of the second touch region 47b. Afterwards, while the first touch region 47a and the second touch region 47b are continuously extracted, the event recognition section 130 tracks a distance Dk between a representative point Pak for this first touch region 47a and a representative point Pbk for this second touch region 47b. Then, the event recognition section 130 calculates a difference (Dk−D0) between the calculated distance Dk and the initial distance D0 as an amount of change in the distance. Here, in the case where this difference becomes equal to or less than a predetermined negative threshold, the event recognition section 130 recognizes a GATHER event as an input event. Further, in the case where this difference becomes equal to or more than a predetermined positive threshold, the event recognition section 130 recognizes a SPLIT event as an input event. Note that the above described representative points are not limited to the center of gravity of the touch region 47, and may be other coordinates (for example, a circumcenter of the touch region 47).

By using such an amount of change in the distance, it becomes possible to judge whether the distance between the two touch regions becomes larger or becomes smaller, by a simple operation.

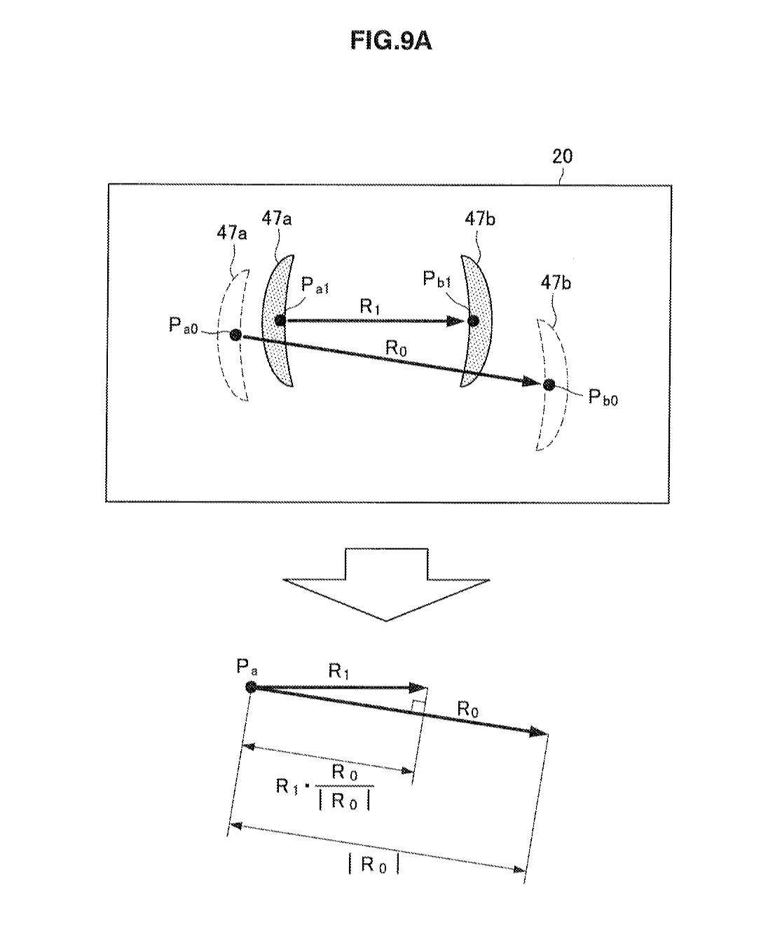

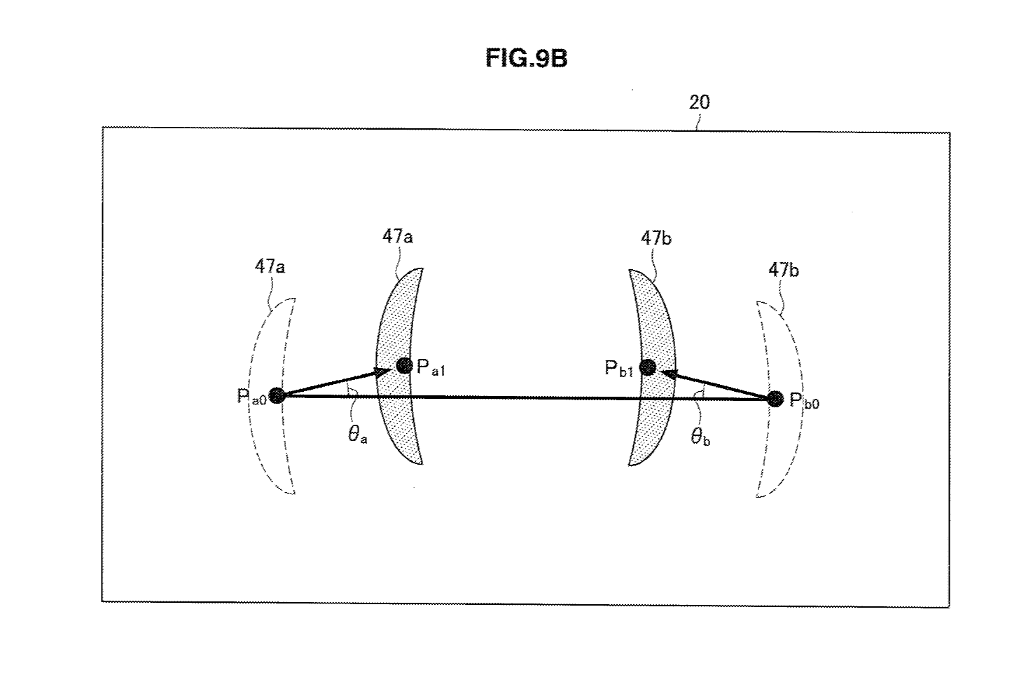

Note that the event recognition section 130 may recognize an input event (that is, a GATHER event or a SPLIT event), based on a relative moving direction between the first touch region and the second touch region. Hereinafter, this point will be described more specifically with reference to FIG. 9A.

FIG. 9A is an explanatory diagram for describing an example of the recognition of an input event, based on a relative moving direction between two touch regions. Referring to FIG. 9A, in the upper section, the touch panel 20 is shown. Here, similar to that of FIG. 8, when the first touch region 47a and the second touch region 47b are extracted, the event recognition section 130 determines a representative point Pa0 for this first touch region 47a and a representative point Pb0 for this second touch region 47b. Then, the event recognition section 130 calculates a vector R0 from the representative point Pa0 to the representative point Pb0, as a relative position of the second touch region 47b to the first touch region 47a. Further, the event recognition section 130, for example, determines a representative point Pa1 for the first touch region 47a extracted after a predetermined period has elapsed, and a representative point Pb1 for the second touch region 47b extracted after this predetermined period has elapsed. Then, the event recognition section 130 calculates a vector R1 from the representative point Pa1 to the representative point Pb1, as a relative position of the second touch region 47b to the first touch region 47a.

Next, in the lower section of FIG. 9A, a position of the second touch region 47b in the case where the representative point Pa of the first touch region 47a is made an origin point, that is, the vectors R0 and R1, are displayed. Here, the event recognition section 130 calculates an inner product between the vector R1 and a unit vector R0/|R0| in the same direction as the vector R0. Then, the event recognition section 130 compares this inner product with the size |R0| of the vector R0. Here, if this inner product is smaller than |R0|, the event recognition section 130 judges that the relative moving direction between the first touch region and the second touch region is a direction where they are approaching one another. Further, if this inner product is larger than |R0|, the event recognition section 130 judges that the above described relative moving direction is a direction where they are separating from one another. Then, in the case where this relative moving direction is a direction where the first touch region and the second touch region are approaching one another, the event recognition section 130 recognizes a GATHER event, and in the case where this relative moving direction is a direction where the first touch region and the second touch region are separating from one another, the event recognition section 130 recognizes a SPLIT event.

By using such a relative moving direction, it becomes possible to judge whether the distance between the two touch regions becomes smaller or becomes larger.

Further, the event recognition section 130 may recognize an input event (that is, a GATHER event or a SPLIT event), based on a moving direction of the first touch region and a moving direction of the second touch region. Hereinafter, this point will be described more specifically with reference to FIG. 9B.

FIG. 9B is an explanatory diagram for describing an example of the recognition of an input event, based on a moving direction of two touch regions. Referring to FIG. 9B, the touch panel 20 is shown. Here, similar to that of FIG. 9A, representative points Pa0 and Pa1 for the first touch region 47a, and representative points Pb0 and Pb1 for the second touch region 47b, are determined by the event recognition section 130. Then, the event recognition section 130 calculates an angle θa made by the direction from the representative point Pa0 to the representative point Pa1, and the direction from the representative point Pa0 to the representative point Pb0, as a moving direction of the first touch region 47a. Further, the event recognition section 130 calculates an angle θb made by the direction from the representative point Pb0 to the representative point Pb1, and the direction from the representative point Pb0 to the representative point Pa0, as a moving direction of the second touch region 47b. Here, if both of the angles θa and θb are within the range of 0° to α (for example, 0° to 15°), the event recognition section 130 recognizes a GATHER event. Further, if both of the angles θa and θb are within the range of 180°-α to 180° (for example, 165° to 180°), the event recognition section 130 recognizes a SPLIT event.

By using such moving directions, it becomes possible to judge whether the distance between the two touch regions becomes smaller or becomes larger. Further, since it can be judged how both of the two touch regions have moved and not simply just the distance, a condition for recognizing an input event (GATHER event and SPLIT event) can be more strictly defined.

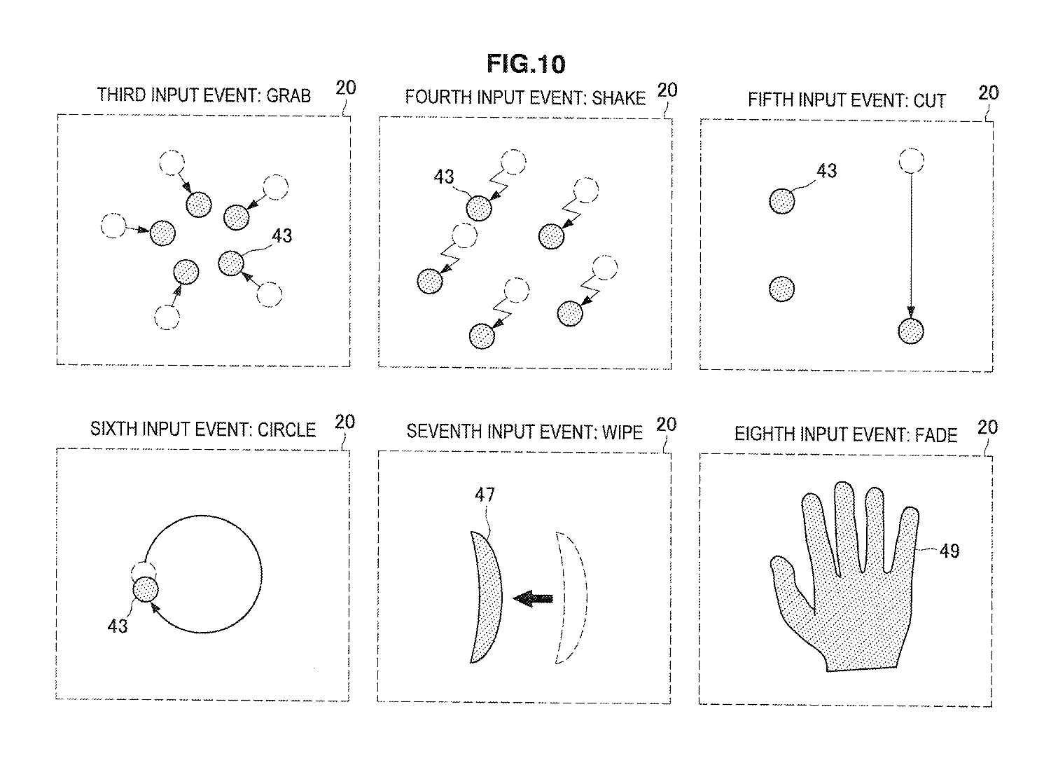

Heretofore, the recognition of a GATHER event and SPLIT event has been described. In addition, the event recognition section 130 may recognize other input events, in addition to these input events. Hereinafter, this point will be described more specifically with reference to FIG. 10.

### —Other Input Events

FIG. 10 is an explanatory diagram for describing examples of the recognition of other input events. Hereinafter, each of six input event examples will be described.

Referring to FIG. 10, first in the case where five touch positions 43 move so as to be mutually approaching one another, the event recognition section 130 may recognize a GRAB event as a third input event. More specifically, for example, when five touch positions 43 are detected, the event recognition section 130 calculates the center of gravity of the five touch positions 43, calculates the distance between this center of gravity and each of the five touch positions 43, and calculates a sum total of the calculated five distances as an initial value. Then, while the five touch positions 43 are continuously detected, the event recognition section 130 tracks the sum total of the five distances, and calculates a difference (sum total−initial value) between this sum total and the initial value. Here, in the case where this difference is equal to or less than a predetermined negative threshold, the event recognition section 130 recognizes a GRAB event. This GRAB event, for example, corresponds to a touch gesture in which the five fingers of the user's hand 41 move so as to converge while touching the touch panel 20. Note that a radius or diameter of a circumscribed circle of the five touch positions 43 may be used instead of this sum total of distances.

Further, in the case where all five touch positions 43 move by changing direction, the event recognition section 130 may recognize a SHAKE event as a fourth input event. More specifically, for example, while the five touch positions 43 are continuously detected, the event recognition section 130 tracks whether or not the moving direction of the five touch positions 43 has changed. This moving direction, for example, is a direction from the previous touch position to the latest touch position. Further, the change of the moving direction is an angle made by the latest moving direction (a direction from the previous touch position to the latest touch position) and the previous moving direction (a direction from the touch position prior to the previous touch position to the previous touch position). In the case where the angle made by this exceeds a predetermined threshold, the event recognition section 130 judges that the moving direction has changed. In the case where it is judged two times that such a moving direction has changed, the event recognition section 130 recognizes a SHAKE event. This SHAKE event, for example, corresponds to a touch gesture in which the five fingers of the user's hand 41 move so as to shake while touching the touch panel 20.

Further, in the case where two touch positions from among three touch positions are stationary, and the other touch position moves in one direction, the event recognition section 130 may recognize a CUT event as a fifth input event. More specifically, for example, while the three touch positions 43 are continuously detected, the event recognition section 130 judges whether or not two of the touch positions are not changing, and judges a start and an end of the movement of the other touch position. Then, in the case where it is continuously judged that these two touch positions are not changing and the end of the other touch position has been judged, the event recognition section 130 recognizes a CUT event. This CUT event, for example, corresponds to a touch gesture in which two fingers of one hand are stationary while touching the touch panel 20, and one finger of the other hand moves in one direction while touching the touch panel 20.

Further, in the case where one touch position moves approximately circular, the event recognition section 130 may recognize a CIRCLE event as a sixth input event. More specifically, for example, while the touch position 43 is continuously detected, the event recognition section 130 judges whether or not the latest touch position 43 matches the touch position 43 when the touch started. Then, in the case where the latest touch position 43 matches the touch position 43 when the touch started, the event recognition section 130 judges whether or not a locus of the touch position 43, from the touch position 43 when the touch started to the latest touch position 43, is appropriately circular. Then, in the case where this locus is judged to be appropriately circular, the event recognition section 130 recognizes a CIRCLE event. This CIRCLE event, for example, corresponds to a touch gesture in which one finger moves by drawing a circle while touching the touch panel 20.

Further, in the case where one touch region 47 moves in one direction, the event recognition section 130 may recognize a WIPE event as a seventh input event. More specifically, for example, while this one touch region 47 is continuously detected, the event recognition section 130 determines a representative point of this one touch region 47 as an initial representative point. Afterwards, while this one touch region 47 is continuously extracted, the event recognition section 130 tracks the representative point of the touch region 47, and calculates the distance between this representative point and the initial representative point. In the case where this distance becomes equal to or more than a predetermined threshold, the event recognition section 130 recognizes a WIPE event. This WIPE event, for example, corresponds to a touch gesture in which a specified part (for example, the side surface) of the user's hand 41 moves in one direction while touching the touch panel 20.

Further, in the case where a palm region 49 is extracted, the event recognition section 130 may recognize a FADE event as an eighth input event. More specifically, for example, when the touch region extraction section 120 extracts the palm region 49, the event recognition section 130 recognizes a FADE event. In this case, apart from the region extraction condition for the above described touch region 47, a region extraction condition for the palm region 49 (for example, a shape condition or a size condition) is prepared. This FADE event, for example, corresponds to a touch gesture in which the palm of the user's hand 41 touches the touch panel 20.

Heretofore, examples of other input events have been described. Note that the touch positions 43 in FIG. 10 are examples. For example, the touch positions 43 may be replaced with touch position sets.

### (Control Section 140)

The control section 140 controls all the operations of the information processing apparatus 100, and provides application functions to the user of the information processing apparatus 100. The control section 140 includes a display control section 141 and a data editing section 143.

### (Display Control Section 141)

The display control section 141 determines the display content in the display section 160, and displays an output image corresponding to this display content on the display section 160. For example, the display control section 141 changes the display of an object displayed on the touch panel 20, according to the recognized input event. In particular, the display control section 141 changes the display of an object to be operated, which is displayed between a first touch region and a second touch region, according to the recognized input event (for example, a GATHER event or a SPLIT event), based on a change in the distance between the first touch region and the second touch region.

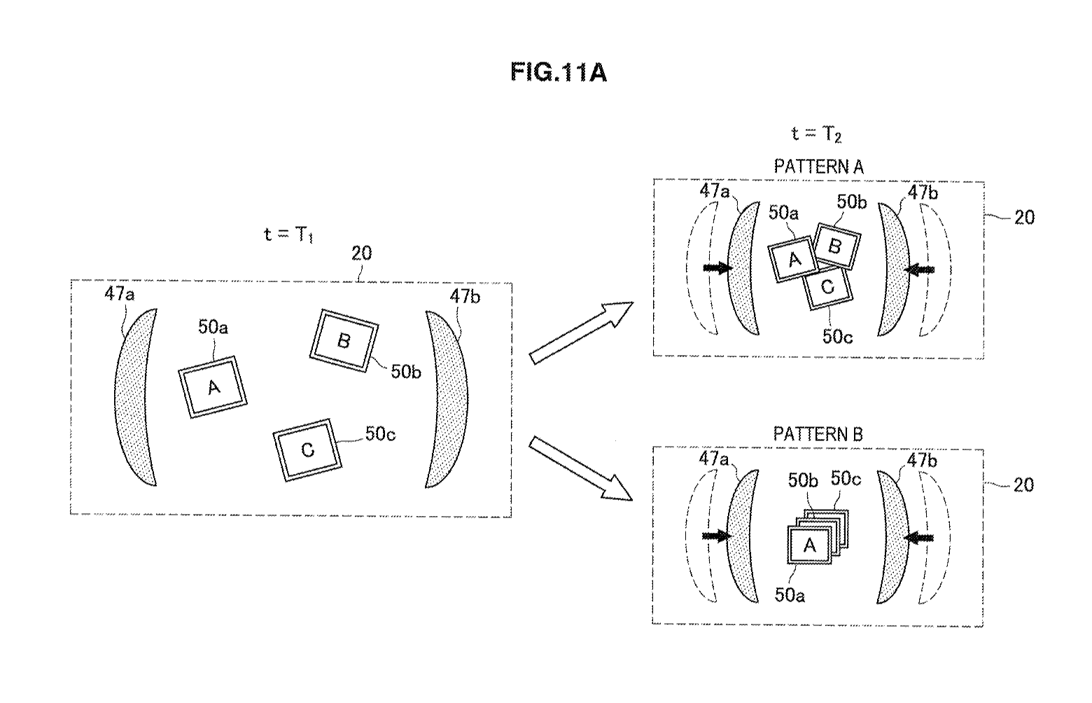

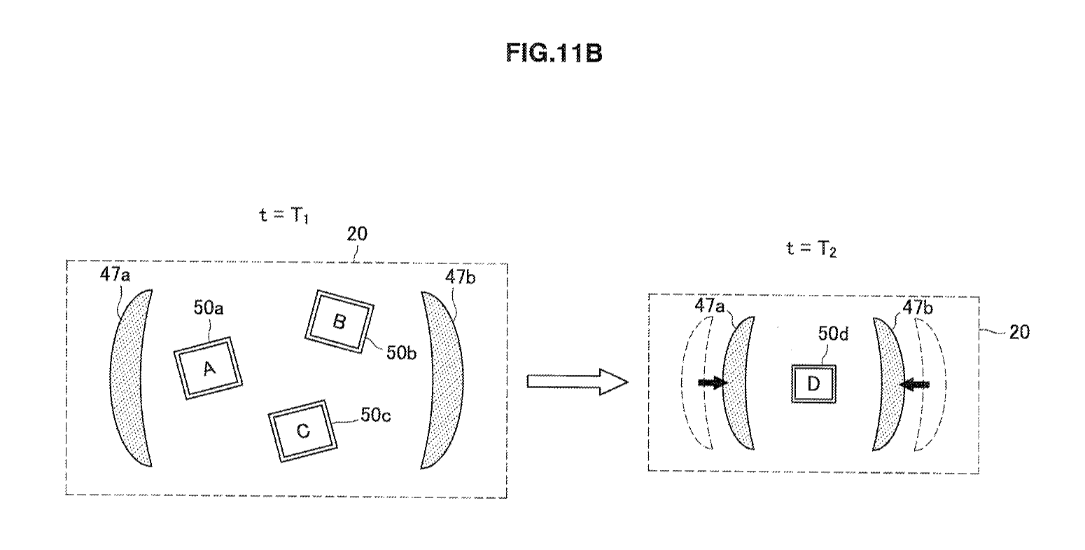

For example, in the case where a GATHER event is recognized, the display control section 141 repositions the objects to be operated in a narrower range. That is, the display control section 141 repositions a plurality of objects to be operated, which are part or all of the objects to the operated displayed before the recognition of the GATHER event, so as to place them in a narrower range after the recognition of the GATHER event. Hereinafter, this point will be described more specifically with reference to FIG. 11A.

FIG. 11A is an explanatory diagram for describing an example of the change of display for objects to be operated by a GATHER event. Referring to FIG. 11A, part of the touch panel 20 is shown. Further, at a time T1, three objects 50a, 50b, and 50c are displayed on the part of the touch panel 20. Here, first the first touch region 47a and the second touch region 47b are extracted. Next, at a time T2, the distance between the first touch region 47a and the second touch region 47b becomes smaller, and a GATHER event is recognized as an input event. Then, for example, such as in pattern A, the display control section 141 changes the position of the three objects 50a, 50b, and 50c so that they become closer to one another, according to the change of the position of the first touch region 47a and the second touch region 47b. Alternatively, the display control section 141, such as in pattern B, changes the position of the three objects 50a, 50b, and 50c, so that the three objects 50a, 50b, and 50c are superimposed in the range between the first touch region 47a and a second touch region 47b.

Further, for example, in the case where a GATHER event is recognized, the display control section 141 converts a plurality of objects to the operated into one object to be operated. That is, the display control section 141 converts a plurality of objects to be operated, which are part or all of the objects to the operated displayed before the recognition of the GATHER event, into one object to be operated after the recognition of the GATHER event. Hereinafter, this point will be described more specifically with reference to FIG. 11B.

FIG. 11B is an explanatory diagram for describing another example of the change of display for objects to be operated by a GATHER event. Referring to FIG. 11B, similar to that of FIG. 11A, at a time T1, three objects 50a, 50b, and 50c are displayed on the part of the touch panel 20, and the first touch region 47a and the second touch region 47b are extracted. Next, at a time T2, the distance between the first touch region 47a and the second touch region 47b becomes smaller, and a GATHER event is recognized as an input event. Then, for example, the display control section 141 converts the three objects 50a, 50b, and 50c into one new object 50d.

According to the change of display by a GATHER event such as described above, for example, the user can consolidate objects 50, which are scattered in a wide range within the touch panel 20, by an intuitive touch gesture such as gathering up the objects 50 with both hands. Here, since the user uses both hands, operations can be performed for objects placed in a wide range of a large-sized touch panel with less of a burden, and where large movements of the user's body may not be necessary.

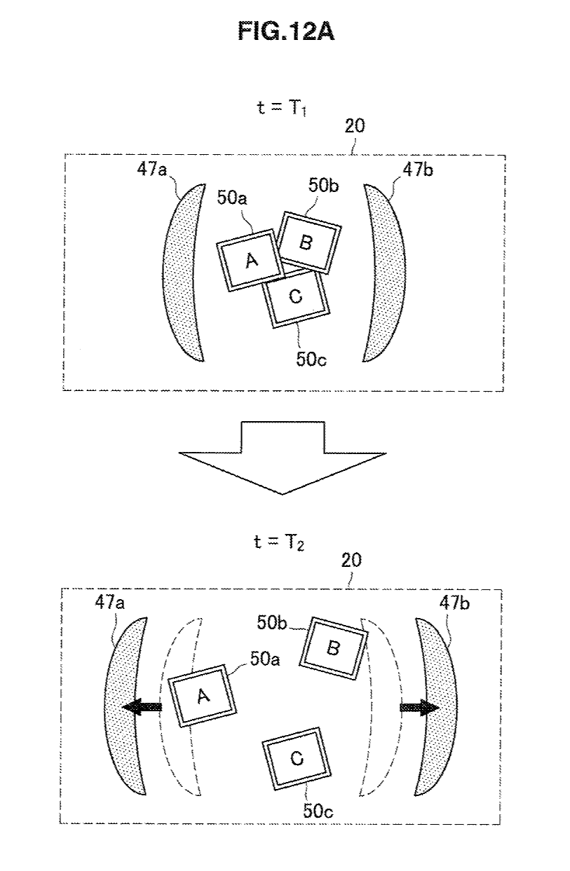

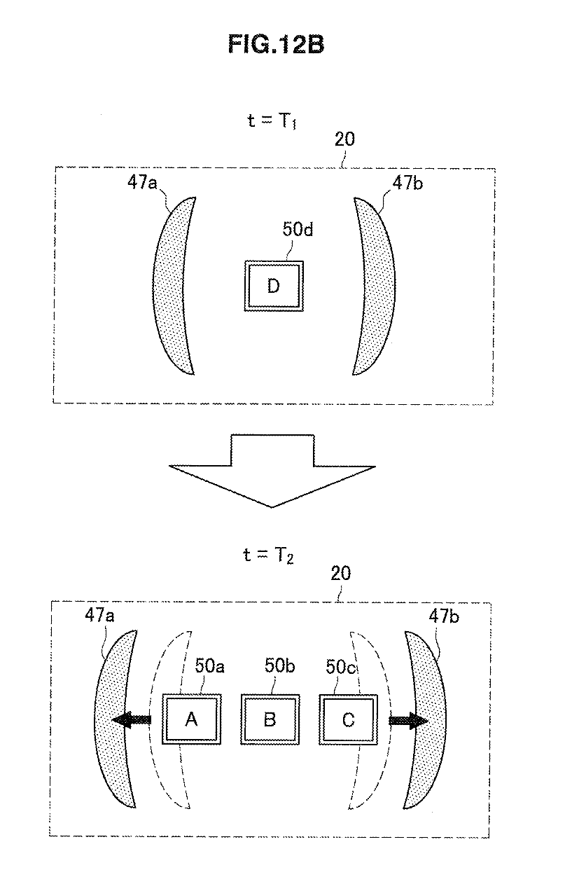

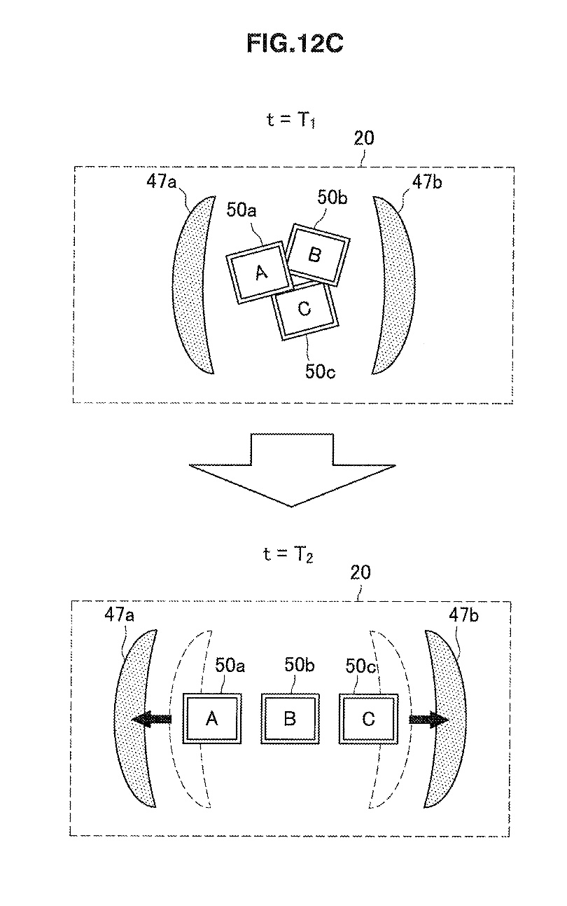

Further, for example, in the case where a SPLIT event is recognized, the display control section 141 repositions a plurality of objects to be operated in a wider range. That is, the display control section 141 repositions a plurality of objects to be operated, which are part or all of the objects to the operated displayed before the recognition of the SPLIT event, so as to be scattered in a wider range after the recognition of the SPLIT event. Hereinafter, this point will be described more specifically with reference to FIG. 12A.

First, FIG. 12A is an explanatory diagram for describing a first example of the change of display for objects to be operated by a SPLIT event. Referring to FIG. 12A, part of the touch panel 20 is shown. Further, at a time T1, three objects 50a, 50b, and 50c are displayed on the part of the touch panel 20. Here, first the first touch region 47a and the second touch region 47b are extracted. Next, at a time T2, the distance between the first touch region 47a and the second touch region 47b becomes larger, and a SPLIT event is recognized as an input event. Then, the display control section 141 changes the position of the three objects 50a, 50b, and 50c so that they become more distant from one another, according to the change of position of the first touch region 47a and the second touch region 47b.

Further, for example, in the case where a SPLIT event is recognized, the display control section 141 converts one object to be operated into a plurality of objects to be operated. That is, the display control section 141 converts one object to be operated, which is part or all of the objects to be operated displayed before the recognition of the SPLIT event, into a plurality of objects to be operated after the recognition of the SPLIT event. Hereinafter, this point will be described more specifically with reference to FIG. 12B.

Further, FIG. 12B is an explanatory diagram for describing a second example of the change of display for objects to be operated by a SPLIT event. Referring to FIG. 12B, part of the touch panel 20 is shown. Further, at a time T1, one object 50d is displayed on the part of the touch panel 20. Here, first the first touch region 47a and the second touch region 47b are extracted. Next, at a time T2, the distance between the first touch region 47a and the second touch region 47b becomes larger, and a SPLIT event is recognized as an input event. Then, the display control section 141 converts this one object 50d into three new objects 50a, 50b, and 50c.

Further, for example, in the case where a SPLIT event is recognized, the display control section 141 may align the plurality of objects to be operated displayed before the recognition of the SPLIT event. That is, the display control section 141 aligns the plurality of objects to be operated, which are part or all of the objects to the operated displayed before the recognition of the SPLIT event, after the recognition of the SPLIT event. Hereinafter, this point will be described more specifically with reference to FIG. 12C.

Further, FIG. 12C is an explanatory diagram for describing a third example of the change of display for objects to be operated by a SPLIT event. Referring to FIG. 12C, similar to that of FIG. 12A, at a time T1, three objects 50a, 50b, and 50c are displayed on the part of the touch panel 20, and the first touch region 47a and the second touch region 47b are extracted. Next, at a time T2, the distance between the first touch region 47a and the second touch region 47b becomes larger, and a SPLIT event is recognized as an input event. Then, the display control section 141 aligns the three objects 50a, 50b, and 50c.

According to such a change of display by a SPLIT event, for example, the user can deploy objects 50 consolidated within the touch panel 20 in a wide range, or can arrange objects 50 placed without order, by an intuitive touch gesture such as spreading the objects 50 with both hands. As a result, it becomes easier for the user to view the objects 50. Here, since the user uses both hands, operations can be performed for objects deployed or arranged in a wide range of a large-sized touch panel with less of a burden, and where large movements of the user's body may not be necessary.

Note that while FIGS. 11A to 12C have been described for the case where all the objects 50, which are displayed between the first touch region 47a and the second touch region 47b, are the objects to the operated, the present embodiments are not limited to this. For example, part of the objects, which are displayed between the first touch region 47a and the second touch region 47b, may be the objects to the operated. Further, the display may be changed for each type of object to be operated. For example, in the case where a SPLIT event is recognized, the display control section 141 may separately arrange the objects to be operated corresponding to a photograph, and the objects to the operated corresponding to a moving image.

### (Data Editing Section 143)

The data editing section 143 performs editing of data. For example, the data editing section 143 performs uniting or dividing of data corresponding to objects, according to the recognized input event. In particular, the data editing section 143 unites or divides data corresponding to objects to the operated, which are displayed between the first data region and the second data region, according to the recognized input event (for example, a GATHER event or a SPLIT event), based on a change in the distance between the first touch region and the second touch region.

For example, in the case where a GATHER event is recognized, the data editing section 143 unites data corresponding to a plurality of objects to be operated displayed before the recognition of the GATHER event. As an example, this data is a moving image. For example, the three objects 50a, 50b, and 50c at a time T1, which is shown in FIG. 11B, may each correspond to a moving image. Then, when a GATHER event is recognized at a time T2, the data editing section 143 unites the three moving images corresponding to the three objects 50a, 50b, and 50c. In this case, for example, as shown in FIG. 11B, the three objects 50a, 50b, and 50c are converted into one object 50d, and this object 50d corresponds to a moving image after being united.

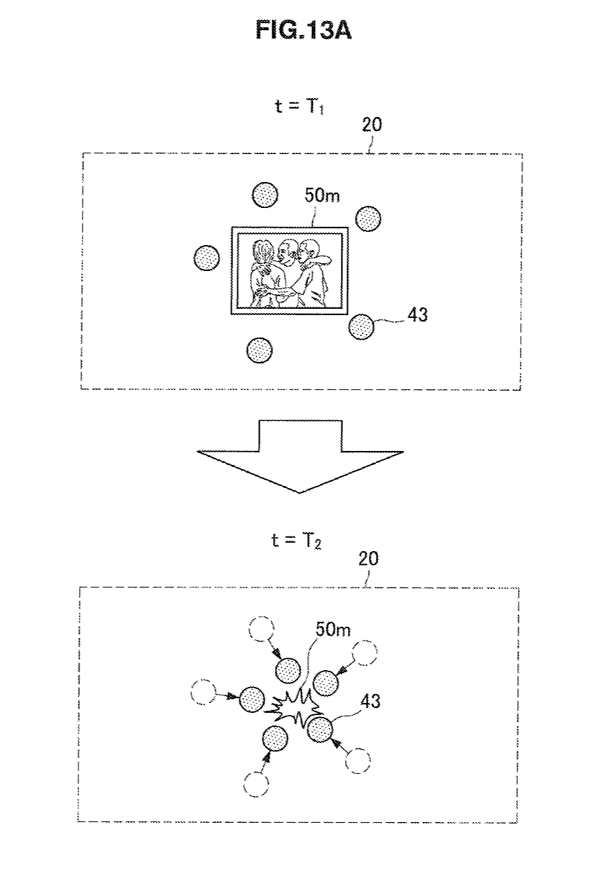

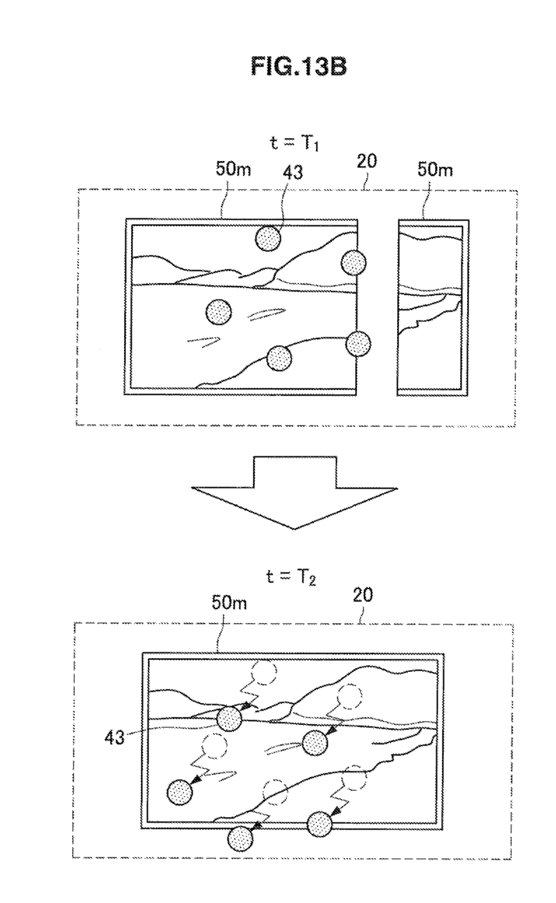

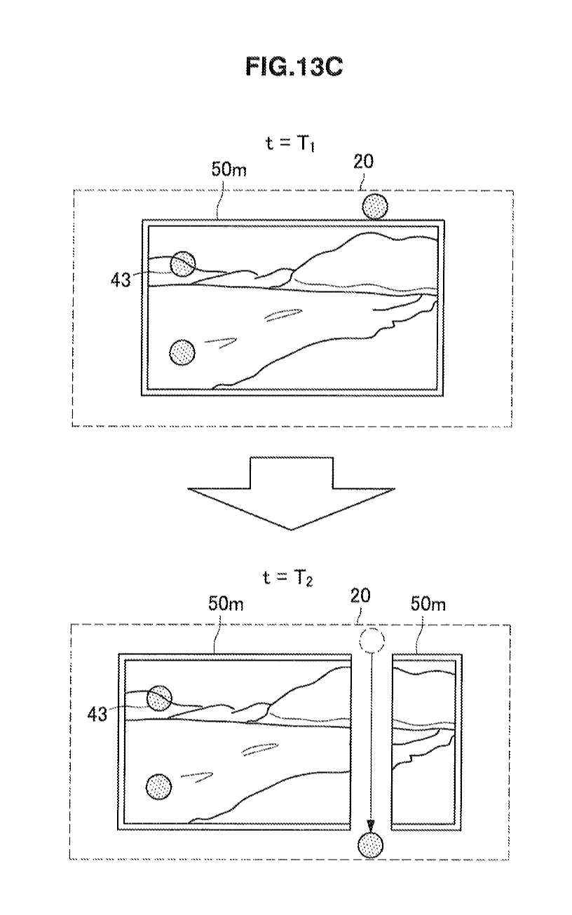

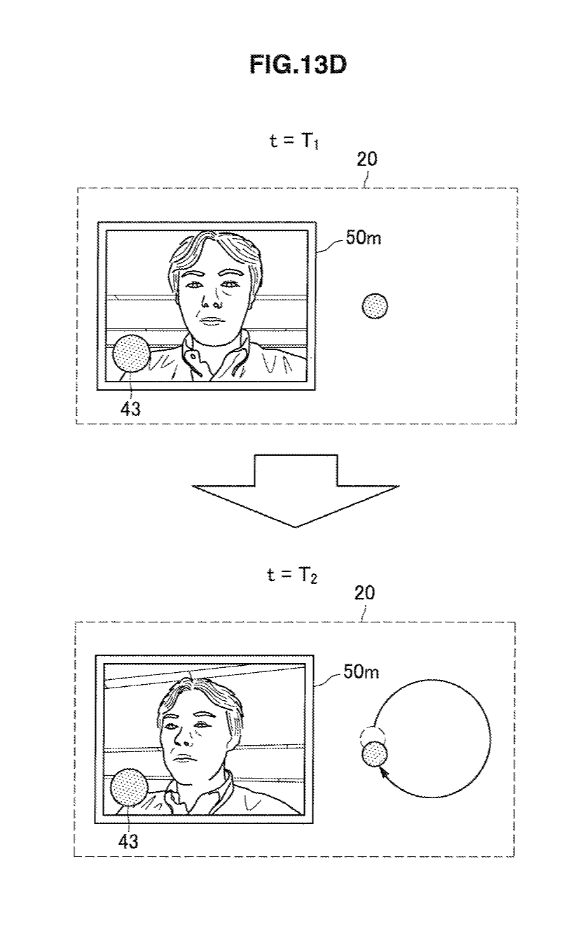

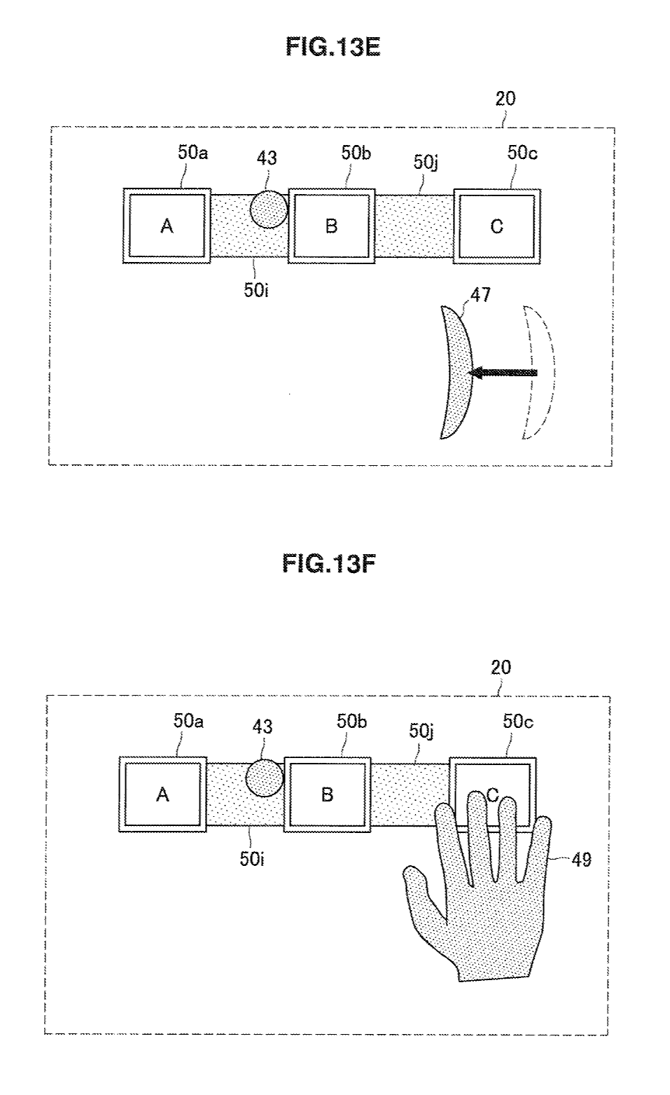

Further, for example, in the case where a SPLIT event is recognized, the data editing section 143 divides data corresponding to one object to be operated displayed before the recognition of the SPLIT event. As an example, this data is a moving image. For example, this one object 50d at a time T1, which is shown in FIG. 12B, may correspond to a moving image. Then, when a SPLIT event is recognized at a time T2, the data editing section 143 divides the moving image corresponding to the object 50d into three moving images. In this case, for example, as shown in FIG. 12B, this one object 50d is converted into three objects 50a, 50b, and 50c, and these three objects 50a, 50b, and 50c correspond to three moving images after being divided. Note that the number of moving images after being divided and the dividing position, for example, may be determined according to a result of scene recognition for the moving image before being divided. Further, as shown in FIGS. 13E and 13F described afterwards, an object corresponding to a visual performance (transition) during a scene transition between images may be displayed between the objects 50a, 50b, and 50c.

From such data uniting by a GATHER event or data dividing by a SPLIT event, a user can easily edit data by an intuitive touch gesture, such as gathering up objects 50 with both hands or spreading objects 50 with both hands. For example, a photograph or a moving image can be easily edited.

Heretofore, operations of the display control section 141 and the data editing section 143 have been described for a GATHER event and SPLIT event. According to an input event such as a GATHER event or SPLIT event, a user can perform operations by an intuitive touch gesture, such as gathering up objects 50 with a specific part (for example, the side surface) of both hands or spreading objects 50 with both hands. Here, since the user uses both hands, operations can be performed for a large-sized touch panel with less of a burden, and where large movements of the user's body may not be necessary. For example, even if the objects for operation are scattered in a wide range of a large-sized screen, an operation target is specified by spreading both hands, and thereafter the user can perform various operations with a gesture integral to this specification.

Hereinafter, operations of the display control section 141 and the data editing section 143 will be described for six input events other than a GATHER event or SPLIT event, with reference to FIGS. 13A to 13F.

### (Display Control and Data Editing for Other Input Events)

FIG. 13A is an explanatory diagram for describing an example of the change of display for an object to be operated by a GRAB event. Referring to FIG. 13A, a GRAB event, which is described with reference to FIG. 10, is recognized. In this case, the display control section 141 alters an object 50m, which is displayed by being enclosed by the five touch positions 43, so as to show a state which has been deleted. Then, the data editing section 143 deletes the data corresponding to the object 50m.

Further, FIG. 13B is an explanatory diagram for describing an example of the change of display for an object to be operated by a SHAKE event. Referring to FIG. 13B, a SHAKE event, which is described with reference to FIG. 10, is recognized. In this case, the display control section 141 alters an object 50m, which is displayed in at least one touch position 43 from among the five touch positions 43, so as to show an original state before the operation. For example, the display control section 141 alters the object 50m, which shows a state which has been trimmed, so as to show a state before being trimmed. Then, the data editing section 143 restores (that is, a so-called undo operation is performed) the data corresponding to the object 50m (for example, a photograph after being trimmed) to the data before being trimmed (for example, a photograph before being trimmed).

Further, FIG. 13C is an explanatory diagram for describing an example of the change of display for an object to be operated by a CUT event. Referring to FIG. 13C, a CUT event, which is described with reference to FIG. 10, is recognized. In this case, the display control section 141 alters an object 50m, which is displayed in two stationary touch positions and is intersected in a touch position which moves in one direction, so as to show a state which has been trimmed. Then, the data editing section 143 trims the data (for example, a photograph) corresponding to the object 50m.

Further, FIG. 13D is an explanatory diagram for describing an example of the change of display for an object to be operated by a CIRCLE event. Referring to FIG. 13D, a CIRCLE event, which is described with reference to FIG. 10, is recognized. In this case, there is an object 50m corresponding to a moving frame, and the display control section 141 alters the object 50m, which displays a first frame of this moving image, so as to display a second frame of this moving image (for example, a frame which appears after the first frame). Then, the data editing section 143 acquires a state where this second frame is selected, so as to edit the moving image.

Further, FIG. 13E is an explanatory diagram for describing an example of an operation for objects to be operated by a WIPE event. Referring to FIG. 13E, three objects 50a, 50b, and 50c corresponding to respective moving images are displayed on part of the touch panel 20. Further, objects 50i and 50j corresponding to a visual performance (hereinafter, called a “transition”) during a scene transition between images is displayed between these three objects 50a, 50b, and 50c. Here, a touch position 43 is detected by a touch, and in this way it becomes a state where the object 50i corresponding to a transition is selected. Then, a WIPE event, which is described with reference to FIG. 10, is recognized. In this case, the data editing section 143 sets the transition corresponding to the object 50i to a wipe transition in the direction to which the touch region 47 has moved.

Further, FIG. 13F is an explanatory diagram for describing an example of an operation for objects to be operated by a FADE event. Referring to FIG. 13F, similar to that of FIG. 13E, three objects 50a, 50b, and 50c corresponding to respective moving images, and objects 50i and 50j corresponding to transitions between the moving images, are displayed on the touch panel 20. Further, similar to that of FIG. 13E, it becomes a state where the object 50i corresponding to a transition is selected. Then, a FADE event, which is described with reference to FIG. 10, is recognized. In this case, the data editing section 143 sets the transition corresponding to the object 50i to a fade-in transition or a fade-out transition.

### (Storage Section 150)

The storage section 150 stores information to be temporarily or permanently kept in the information processing apparatus 100. For example, the storage section 150 stores an image of the object 50 displayed on the display section 160. Further, the storage section 150 stores data (such as photographs or moving images) corresponding to this object 50.

### (Display Section 160)

The display section 160 displays an output image, according to a control by the display control section 141. That is, the display control section 160 has a function corresponding to the display surface 23.

### 3. OPERATION EXAMPLES

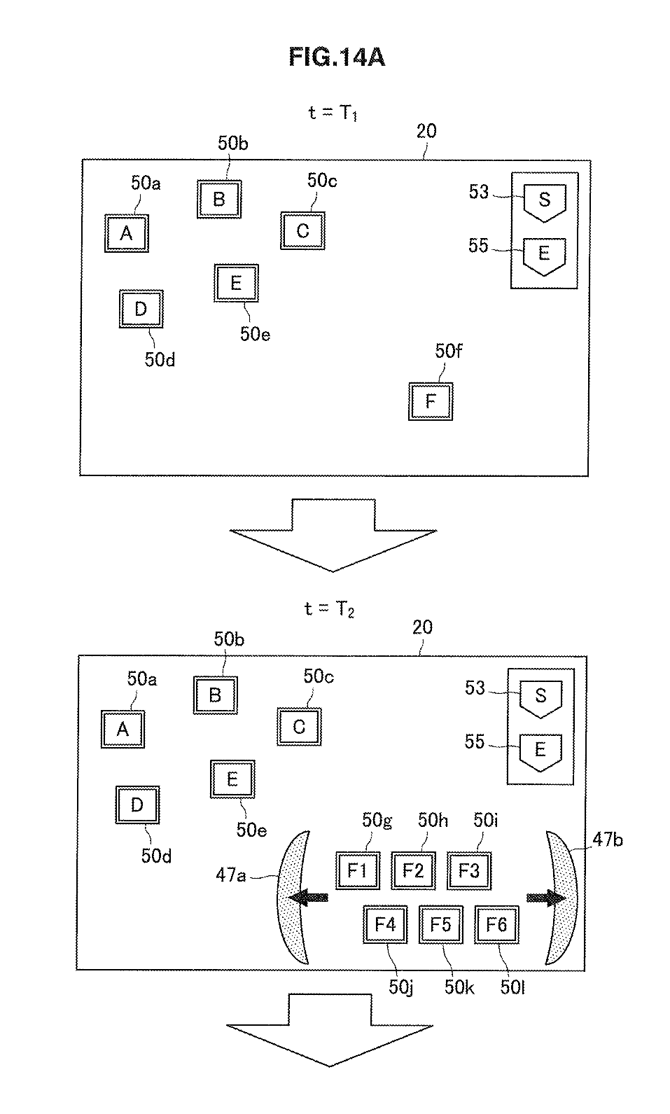

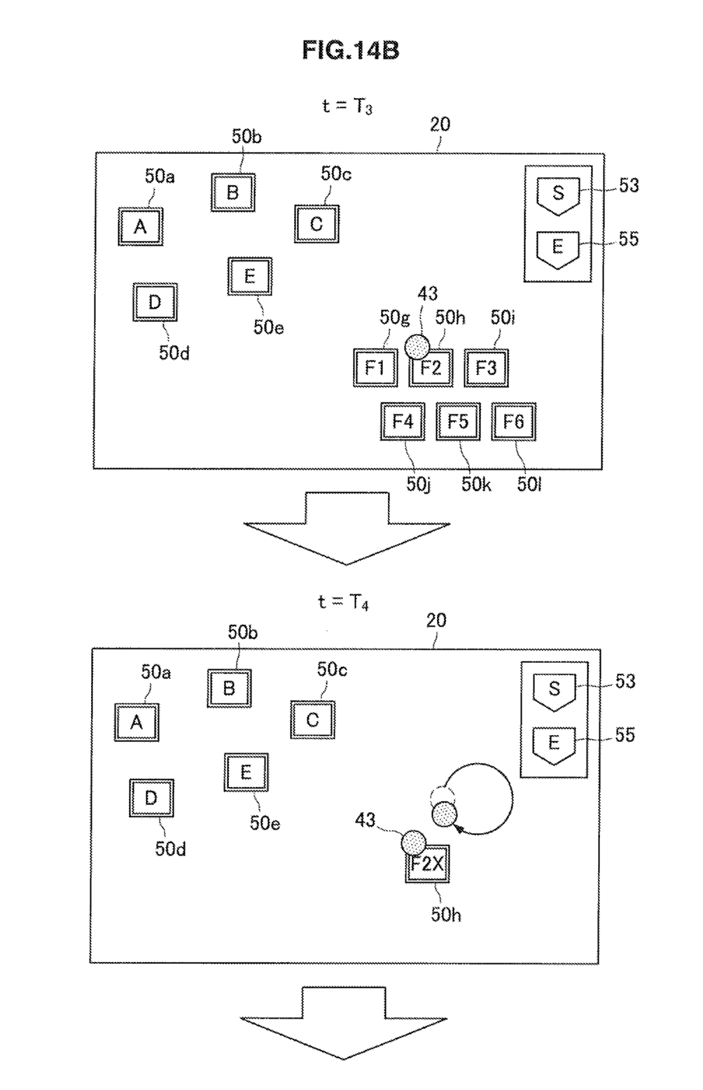

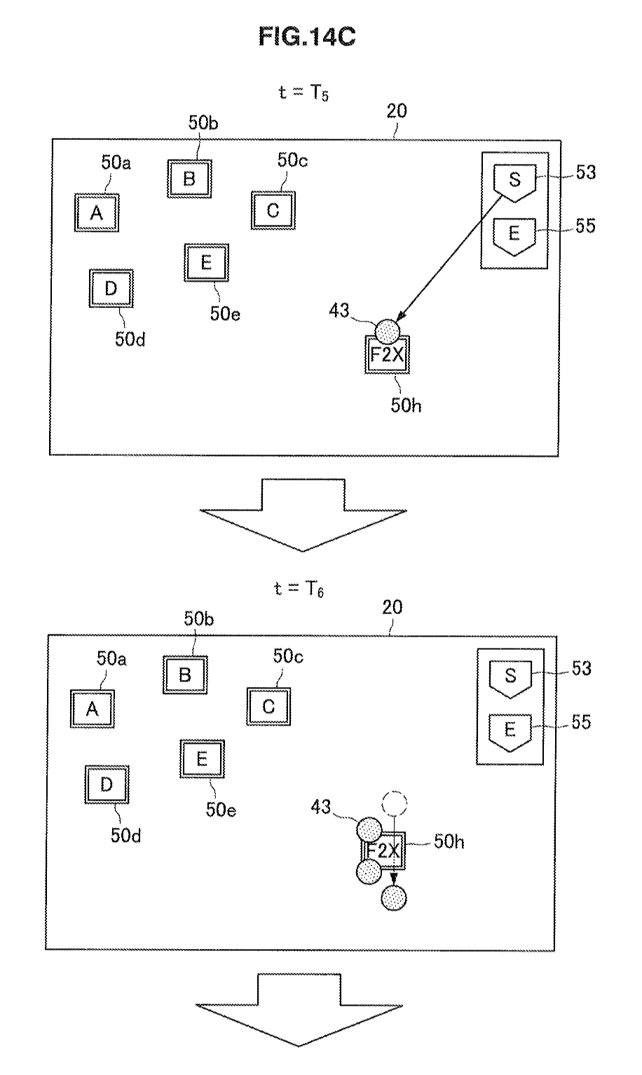

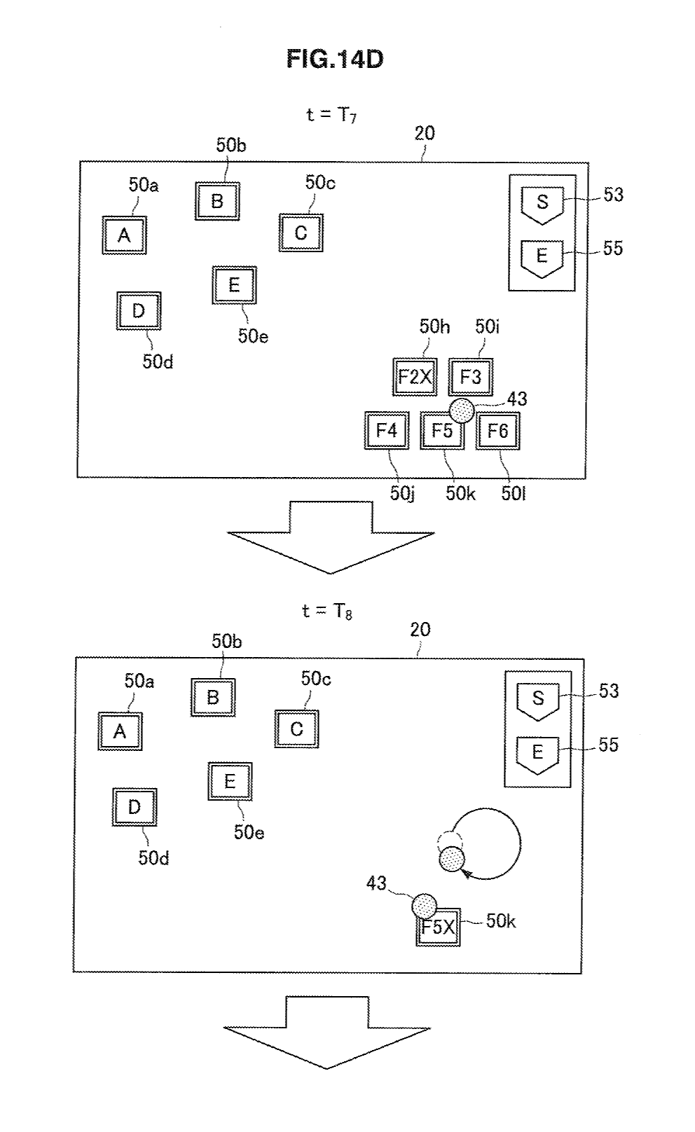

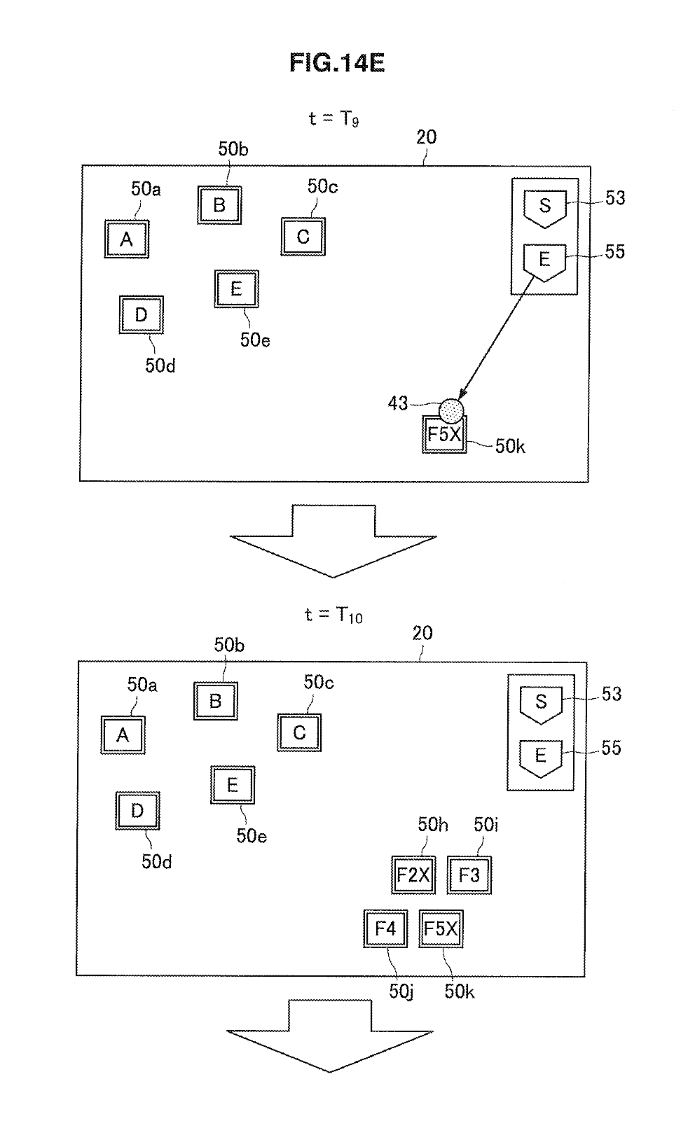

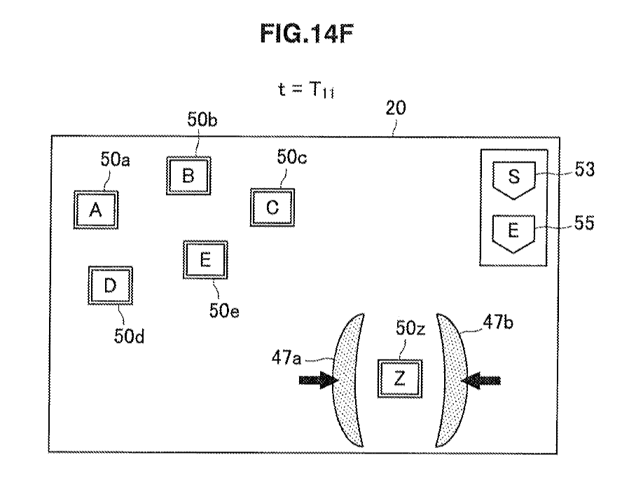

Next, operation examples in the information processing apparatus 100 will be described with reference to FIGS. 14A to 14F. FIGS. 14A to 14F are explanatory diagrams for describing operation examples in the information processing apparatus 100. In the present operation examples, segmentation of a moving image is performed as the editing of a moving image.

First, referring to FIG. 14A, at a time T1, six objects 50a to 50f corresponding to moving images A to F are displayed on the touch panel 20. Further, a start tag 53 and an end tag 55 for editing the moving image are displayed. In the present operation example, hereinafter segmentation of the moving image F is performed.

Next, at a time T2, a SPLIT event, in which the object 50f is made the object to be operated, is recognized. As a result, the object 50F is converted into six objects 50g to 50l in the touch panel 20. Further, the moving image F corresponding to the object 50f is divided into six moving images F1 to F6. Here, the six objects 50g to 50l correspond to these six moving images F1 to F6 after being divided.

Next, referring to FIG. 14B, at a time T3, a touch position 43 is detected, and as a result, it becomes a state where the object 50h and the moving image F2 are selected.

Next, at a time T4, a CIRCLE event is recognized. As a result, the object 50h, which displays a first frame of the moving image F2, is altered so as to display a second frame of this moving image F2. Such an altered object 50h is represented here by F2X. Further, it becomes a state where this second frame of the moving image F2 is selected.

Next, referring to FIG. 14C, at a time T5, the start tag 53 is dragged onto the object 50h. Then, this second frame of the moving image F2 is determined as the start point for editing the moving image F.

Next, at a time T6, a CUT event, in which the object 50h is made a target, is recognized. As a result, segmentation of the moving image is determined as the content for editing. Here, the start point for the segmentation of the moving image F is this second frame of the moving image F2, which has been determined as the start point for editing.

Next, referring to FIG. 14D, at a time T7, the objects 50h to 50l are displayed again. Then, a touch position 43 is detected, and as a result, it becomes a state where the object 50k and the moving image F5 are selected.

Next, at a time T8, a CIRCLE event is recognized. As a result, the object 50k, which displays the first frame of the moving image F5, is altered so as to display a second frame of this moving image F5. Such an altered object 50k is represented here by F5X. Further, it becomes a state where this second frame of the moving image F5 is selected.

Next, referring to FIG. 14E, at a time T9, the end tag 55 is dragged onto the object 50k. Then, this second frame of the moving image F5 is determined as the end point for editing the moving image F. That is, this second frame of the moving image F5 is determined as the end point for the segmentation of the moving image F.

Next, at a time T10, the objects 50h to 50k are displayed again.

Then, referring to FIG. 14F, at a time T11, a GATHER event, in which the objects 50h to 50k are made the objects to be operated, is recognized. As a result, the four objects 50h to 50k are converted into one object 50z in the touch panel 20. Further, the moving objects F2 to F5 corresponding to the four objects 50h to 50k are united, and become one moving image Z. Here, the united moving image F2 is the part of the second and subsequent frames of the moving image F2, and the united moving image F5 is the part before the second frame of the moving image F5. That is, the moving image Z is a moving image of the parts from the second frame of the moving image F2 to just before the second frame of the moving image F5, from within the moving image F.

Heretofore, operation examples of the image processing apparatus 100 have been described. For example, such a segmentation of a moving image is performed.

### <4. Processes Flow>

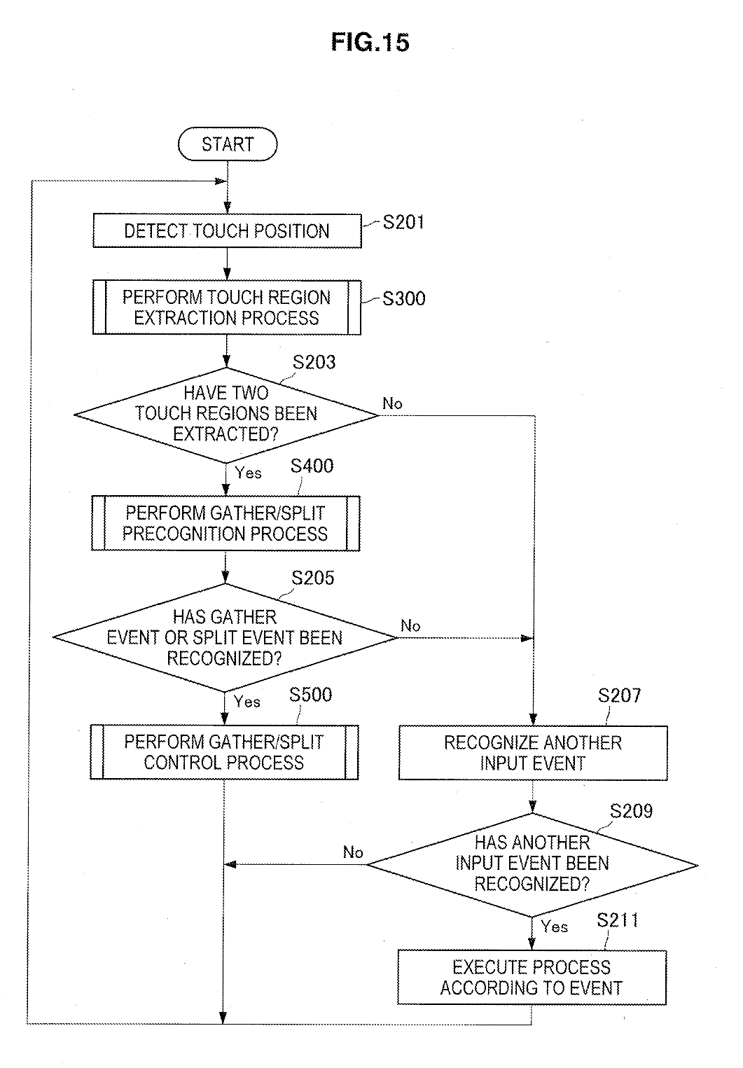

Next, examples of an information process according to the present embodiment will be described with reference to FIGS. 15 to 18. FIG. 15 is a flow chart which shows an example of a schematic flow of an information process according to the present embodiment.

First, in step S201, the touch detection section 110 detects a touch position in the touch panel 20. Next, in step S300, the touch region extraction section 120 executes a touch region extraction process described afterwards. Then, in step S203, the event recognition section 130 judges whether or not two touch regions have been extracted. If two touch regions have been extracted, the process proceeds to step S400. Otherwise, the process proceeds to step S207.

In step S400, the event recognition section 130 executes a GATHER/SPLIT recognition process described afterwards. Next, in step S205, the control section 140 judges whether a GATHER event or a SPLIT event has been recognized. If a GATHER event or a SPLIT event has been recognized, the process proceeds to step S500. Otherwise, the process proceeds to step S207.

In step S500, the control section 140 executes a GATHER/SPLIT control process described afterwards. Then, the process returns to step S201.

In step S207, the event recognition section 130 recognizes another input event other than a GATHER event or SPLIT event. Then, in step S209, the control section 140 judges whether or not another input event has been recognized. If another input event has been recognized, the process proceeds to step S211. Otherwise, the process returns to step S201.

In step S211, the control section 140 executes processes according to the recognized input event. Then, the process returns to step S201.

### (Touch Region Extraction Process 300)

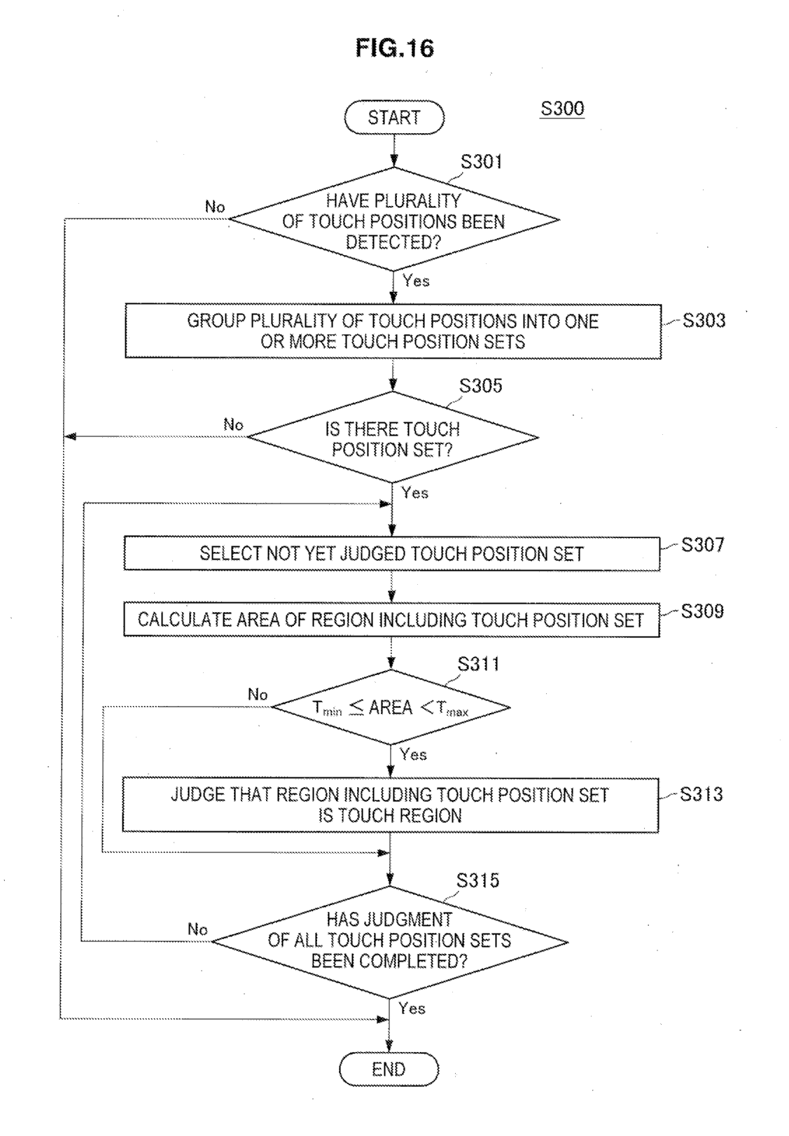

Next, an example of a touch region extraction process S300 will be described. FIG. 16 is a flow chart which shows an example of a touch region extraction process 300. This example is an example in the case where the region extraction condition is a size condition.

First, in step S301, the touch region extraction section 120 judges whether or not a plurality of touch positions have been detected. If a plurality of touch positions have been detected, the process proceeds to step S303. Otherwise, the process ends.

In step S303, the touch region extraction section 120 groups the plurality of touch positions into one or more touch position sets, in accordance with a predetermined grouping condition. In step S305, the touch region extraction section 120 judges whether or not touch position set(s) is(/are) present. If touch position set(s) is(/are) present, the process proceeds to step S307. Otherwise, the process ends.

In step S307, the touch region extraction section 120 selects a touch position set to which judgment of the region extraction condition has not been performed. Next, in step S309, the touch region extraction section 120 calculates an area of the region including the selected touch position set. Then, in step S311, the touch region extraction section 120 judges whether or not the calculated area is equal to or more than a threshold Tmin and less than a threshold Tmax. If the area is equal to or more than the threshold Tmin and less than the threshold Tmax, the process proceeds to step S313. Otherwise, the process proceeds to step S315.

In step S313, the touch region extraction section 120 judges that the region including the selected touch position set satisfies the region extraction condition. That is, the touch region extraction section 120 extracts the region including the selected touch position set as a touch region.

In step S315, the touch region extraction section 120 judges whether or not the judgment of the region extraction condition has been completed for all touch position sets. If this judgment has been completed for all touch position sets, the process ends. Otherwise, the process returns to step S307.

### (GATHER/SPLIT Recognition Process S400)

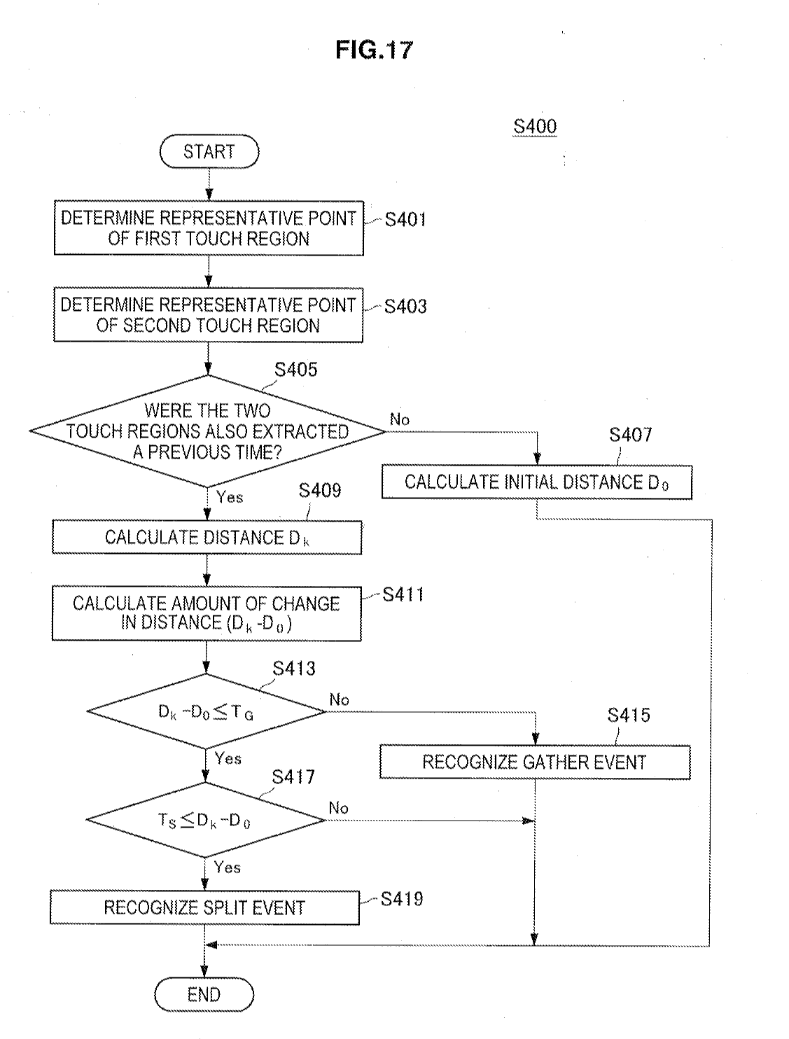

Next, an example of a GATHER/SPLIT recognition process S400 will be described. FIG. 17 is a flow chart which shows an example of a GATHER/SPLIT recognition process. This example is an example in the case where a GATHER event or SPLIT event has been recognized, based on an amount of change in the distance between touch regions.

First, in step S401, the event recognition section 130 determines a representative point of the extracted first touch region. Further, in step S403, the event recognition section 130 determines a representative point of the extracted second touch region. Then, in step S405, the event recognition section 130 judges whether or not the two touch regions were also extracted a previous time. If these two touch regions were also extracted a previous time, the process proceeds to step S409. Otherwise, the process proceeds to step S407.

In step S407, the event recognition section 130 calculates the distance between the two determined representative points as an initial distance D0. Then, the process ends.

In step S409, the event recognition section 130 calculates a distance Dk between the two determined representative points. Next, in step S411, the event recognition section 130 calculates a difference (Dk−D0) between the calculated distance Dk and the initial distance D0 as an amount of change in distance. Then, in step S413, the event recognition section 130 judges whether or not the amount of change in distance (Dk−D0) is equal to or less than a negative threshold TG. If the amount of change in distance (Dk−D0) is equal to or less than the negative threshold TG, the process proceeds to step S415. Otherwise, the process proceeds to step S417.

In step S415, the event recognition section 130 recognizes a GATHER event as an input event. Then, the process ends.

In step S417, the event recognition section 130 judges whether or not the amount of change in distance (Dk−D0) is equal to or more than a positive threshold TS. If the amount of change in distance (Dk−D0) is equal to or more than the positive threshold TS, the process proceeds to step S419. Otherwise, the process ends.

In step S419, the event recognition section 130 recognizes a SPLIT event as an input event. Then, the process ends.

### (GATHER/SPLIT Control Process S500)

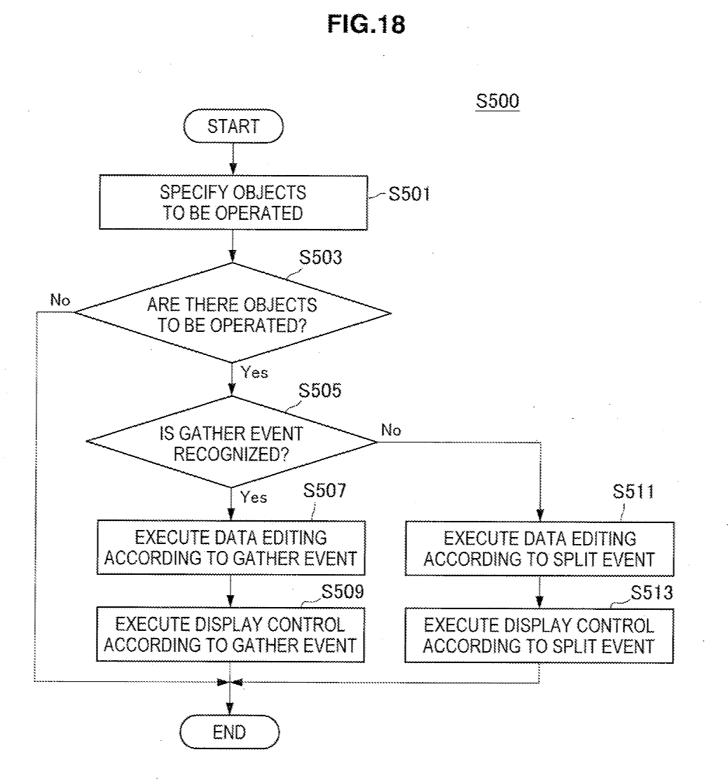

Next, an example of a GATHER/SPLIT control process S500 will be described. FIG. 18 is a flow chart which shows an example of a GATHER/SPLIT control process.

First, in step S501, the display control section 141 specifies objects to be operated, which are displayed between the first touch region and the second touch region. Then, in step S503, the display control section 141 judges whether or not there are objects to be operated. If there are objects to be operated, the process proceeds to step S505. Otherwise, the process ends.

In step S505, the display control section 141 judges whether or not the recognized input event was a GATHER event. If the recognized input event was a GATHER event, the process proceeds to step S507. Otherwise, that is, if the recognized input event was a SPLIT event, the process proceeds to step S511.

In step S507, the data editing section 143 executes editing of the data according to the GATHER event. For example, the data editing section 143 unites the data corresponding to a plurality of objects displayed before the recognition of the GATHER event.

In step S509, the display control section 141 executes a display control according to the GATHER event. For example, as described with reference to FIG. 11A, the display control section 141 may reposition the objects to be operated in a narrower range, or as described with reference to FIG. 11B, the display control section 141 may convert a plurality of objects to be operated into one object to be operated. Then, the process ends.

In step S511, the data editing section 143 executes editing of the data according to the SPLIT event. For example, the data editing section 143 divides the data corresponding to the object displayed before the recognition of the SPLIT event.

In step S513, the display control section 141 executes a display control according to the SPLIT event. For example, as described with reference to FIG. 12A, the display control section 141 may reposition a plurality of objects to be operated in a wider range, or as described with reference to FIG. 12B, the display control section 141 may convert one object to be operated into a plurality of objects to be operated. Alternatively, as described with reference to FIG. 12C, the display control section 141 may align a plurality of objects to be operated displayed before the recognition of the SPLIT event. Then, the process ends.

### 5. CONCLUSION

Thus far, an information processing apparatus 100 according to the embodiments of the present disclosure has been described by using FIGS. 1 to 18. According to the present embodiments, an input event (GATHER event or SPLIT event) is recognized, based on a change in the distance between two touch regions. In this way, a user can perform operations by an intuitive touch gesture, such as gathering up objects 50 displayed on a touch panel 20 with a specific part (for example, the side surface) of both hands or spreading objects 50 with both hands. Here, since the user uses both hands, operations can be performed for a large-sized touch panel with less of a burden, and where large movements of the user's body may not be necessary. For example, even if the objects for operation are scattered in a wide range of a large-sized screen, an operation target is specified by spreading both hands, and thereafter the user can perform various operations with a gesture integral to this specification.

For example, in the case where a GATHER event is recognized, the objects to be operated are positioned in a narrower range. In this way, the user can consolidate objects 50, which are scattered in a wide range within the touch panel 20, by an intuitive touch gesture such as gathering up the objects 50 with both hands. Further, in the case where a SPLIT event is recognized, the objects to be operated are positioned in a wider range, or the objects to be operated are aligned. In this way, the user can deploy objects 50 consolidated within the touch panel 20 in a wide range, or can arrange objects 50 placed without order, by an intuitive touch gesture such as spreading the objects 50 with both hands. As a result, it becomes easier for the user to view the objects 50.

Further, for example, in the case where a GATHER event is recognized, the data corresponding to a plurality of objects to be operated is united. Further, for example, in the case where a SPLIT event is recognized, the data corresponding to one object to be operated is divided. In these cases, a user can easily edit data by an intuitive touch gesture, such as gathering up objects 50 with both hands or spreading objects 50 with both hands.

It should be understood by those skilled in the art that various modifications, combinations, sub-combinations and alterations may occur depending on design requirements and other factors insofar as they are within the scope of the appended claims or the equivalents thereof.

For example, while a case has been described where the touch panel is a contact type which perceives a touch (contact) of the user's hand, the touch panel in the present disclosure is not limited to this. For example, the touch panel may be a proximity type which perceives a proximity state of the user's hand. Further, in this case, the detected touch position may be a position of the proximity of the hand on the touch panel.

Further, while a case has been described where a touch region is extracted according to a touch with the side surface of a hand, the extraction of the touch region in the present disclosure is not limited to this. For example, the touch region may be extracted according to a touch with another part of the hand, such as the ball of a finger, the palm, or the back of the hand. Further, the touch region may be extracted according to a touch other than that with a user's hand.

Further, the technology according to the present disclosure is not limited to a large-sized display device, and can be implemented by various types of devices. For example, the technology according to the present disclosure may be implemented by a device such as a personal computer or a server device, which is directly or indirectly connected to the touch panel without being built-in to the touch panel. In this case, this device may not include the above described touch detection section and display section. Further, the technology according to the present disclosure may be implemented by a device such as a personal computer or a server device, which is directly or indirectly connected to a control device performing display control and data editing of the touch panel. In this case, this device may not include the above described control section and storage section. Further, the technology according to the present disclosure can be implemented in relation to a touch panel other than a large-sized touch panel. For example, the technology according to the present disclosure may be implemented by a device which includes a comparatively small-sized touch panel, such as a smart phone, a tablet terminal, or an electronic book terminal.

Further, the process steps in the information process of an embodiment of the present disclosure may not necessarily be executed in a time series according to order described in the flow charts. For example, the process steps in the information process may be executed in parallel, even if the process steps are executed in an order different to the order described in the flow charts.

Further, it is possible to create a computer program, for displaying the functions equivalent to each configuration of the above described information processing apparatus, in the hardware of a CPU, ROM, RAM or the like which is built-in to the information processing apparatus. Further, a storage medium which stores this computer program may be provided.

Additionally, the present technology may also be configured as below.

(1) An information processing apparatus, including:

an extraction section which extracts a first touch region and a second touch region, each satisfying a predetermined region extraction condition, from a plurality of touch positions detected by a touch panel; and

a recognition section which recognizes an input event, based on a change in a distance between the first touch region and the second touch region.

(2) The information processing apparatus according to (1),

wherein in a case where the distance between the first touch region and the second touch region becomes smaller, the recognition section recognizes a first input event.

(3) The information processing apparatus according to (1) or (2),

wherein in a case where the distance between the first touch region and the second touch region becomes larger, the recognition section recognizes a second input event.

(4) The information processing apparatus according to any one of (1) to (3),

wherein the recognition section recognizes the input event, based on an amount of change in the distance between the first touch region and the second touch region.

(5) The information processing apparatus according to any one of (1) to (3),

wherein the recognition section recognizes the input event, based on a relative moving direction between the first touch region and the second touch region.

(6) The information processing apparatus according to any one of (1) to (3),

wherein the recognition section recognizes the input event, based on a moving direction of the first touch region and a moving direction of the second touch region.

(7) The information processing apparatus according to any one of (1) to (6), further including:

a control section which changes a display of an object to be operated, which is displayed between the first touch region and the second touch region, according to the recognized input event.

(8) The information processing apparatus according to (7),

wherein in a case where the distance between the first touch region and the second touch region becomes smaller, the recognition section recognizes a first input event, and

wherein in a case where the first input event is recognized, the control section repositions an object to be operated in a narrower range.

(9) The information processing apparatus according to (7),

wherein in a case where the distance between the first touch region and the second touch region becomes smaller, the recognition section recognizes a first input event, and

wherein in a case where the first input event is recognized, the control section unites data corresponding to a plurality of objects to be operated displayed before the recognition of the first input event.

(10) The information processing apparatus according to (9),

wherein the data is a moving image.

(11) The information processing apparatus according to (7),

wherein in a case where the distance between the first touch region and the second touch region becomes larger, the recognition section recognizes a second input event, and

wherein in a case where the second input event is recognized, the control section repositions a plurality of objects to be operated in a wider range.

(12) The information processing apparatus according to (7),

wherein in a case where the distance between the first touch region and the second touch region becomes larger, the recognition section recognizes a second input event, and

wherein in a case where the second input event is recognized, the control section aligns a plurality of objects to be operated displayed before the recognition of the second input event.

(13) The information processing apparatus according to (7),

wherein in a case where the distance between the first touch region and the second touch region becomes larger, the recognition section recognizes a second input event, and

wherein in a case where the second input event is recognized, the control section divides data corresponding to one object to be operated displayed before the recognition of the second input event.

(14) The information processing apparatus according to (13),

wherein the data is a moving image.

(15) The information processing apparatus according to any one of (1) to (14),

wherein the region extraction condition includes a condition for a size of a touch region to be extracted.

(16) The information processing apparatus according to any one of (1) to (14),

wherein the region extraction condition includes a condition for a shape of a touch region to be extracted.

(17) The information processing apparatus according to any one of (1) to (14),

wherein the region extraction condition includes a condition for a density of a touch position included in a touch region to be extracted.

(18) An information processing method, including:

extracting a first touch region and a second touch region, each satisfying a predetermined region extraction condition, from a plurality of touch positions detected by a touch panel; and

recognizing an input event, based on a change in a distance between the first touch region and the second touch region.

The present disclosure contains subject matter related to that disclosed in Japanese Priority Patent Application JP 2012-049079 filed in the Japan Patent Office on Mar. 6, 2012, the entire content of which is hereby incorporated by reference.

What is claimed is:

1. An information processing apparatus, comprising:
an extraction section which extracts a first touch region and a second touch region, each satisfying a predetermined region extraction condition, from a plurality of touch positions detected by a touch panel; and
a recognition section which recognizes an input event, based on a change in a distance between the first touch region and the second touch region.

2. The information processing apparatus according to claim 1,
wherein in a case where the distance between the first touch region and the second touch region becomes smaller, the recognition section recognizes a first input event.

3. The information processing apparatus according to claim 1,
wherein in a case where the distance between the first touch region and the second touch region becomes larger, the recognition section recognizes a second input event.

4. The information processing apparatus according to claim 1,
wherein the recognition section recognizes the input event, based on an amount of change in the distance between the first touch region and the second touch region.

5. The information processing apparatus according to claim 1,
wherein the recognition section recognizes the input event, based on a relative moving direction between the first touch region and the second touch region.

6. The information processing apparatus according to claim 1,
wherein the recognition section recognizes the input event, based on a moving direction of the first touch region and a moving direction of the second touch region.

7. The information processing apparatus according to claim 1, further comprising:
a control section which changes a display of an object to be operated, which is displayed between the first touch region and the second touch region, according to the recognized input event.

8. The information processing apparatus according to claim 7,
wherein in a case where the distance between the first touch region and the second touch region becomes smaller, the recognition section recognizes a first input event, and
wherein in a case where the first input event is recognized, the control section repositions an object to be operated in a narrower range.

9. The information processing apparatus according to claim 7,
wherein in a case where the distance between the first touch region and the second touch region becomes smaller, the recognition section recognizes a first input event, and
wherein in a case where the first input event is recognized, the control section unites data corresponding to a plurality of objects to be operated displayed before the recognition of the first input event.

10. The information processing apparatus according to claim 9,
wherein the data is a moving image.

11. The information processing apparatus according to claim 7,
wherein in a case where the distance between the first touch region and the second touch region becomes larger, the recognition section recognizes a second input event, and
wherein in a case where the second input event is recognized, the control section repositions a plurality of objects to be operated in a wider range.

12. The information processing apparatus according to claim 7,
wherein in a case where the distance between the first touch region and the second touch region becomes larger, the recognition section recognizes a second input event, and
wherein in a case where the second input event is recognized, the control section aligns a plurality of objects to be operated displayed before the recognition of the second input event.

13. The information processing apparatus according to claim 7,
wherein in a case where the distance between the first touch region and the second touch region becomes larger, the recognition section recognizes a second input event, and
wherein in a case where the second input event is recognized, the control section divides data corresponding to one object to be operated displayed before the recognition of the second input event.

14. The information processing apparatus according to claim 13,
wherein the data is a moving image.

15. The information processing apparatus according to claim 1,
wherein the region extraction condition includes a condition for a size of a touch region to be extracted.

16. The information processing apparatus according to claim 1,
wherein the region extraction condition includes a condition for a shape of a touch region to be extracted.

17. The information processing apparatus according to claim 1,
wherein the region extraction condition includes a condition for a density of a touch position included in a touch region to be extracted.

18. An information processing method, comprising:
extracting a first touch region and a second touch region, each satisfying a predetermined region extraction condition, from a plurality of touch positions detected by a touch panel; and
recognizing an input event, based on a change in a distance between the first touch region and the second touch region.
